(19) United States
(12) Patent Application Publication
(10) Pub. No.: US 2023/0259901 A1
(43) Pub. Date: Aug. 17, 2023

(54) ISSUING ENTITY AND METHOD FOR ISSUING ELECTRONIC COIN DATA SETS, AND PAYMENT SYSTEM

(71) Applicant: GIESECKE+DEVRIENT ADVANCE52 GMBH, Munchen (DE)

(72) Inventor: Raoul-Thomas HERBORG, Worthsee (DE)

(21) Appl. No.: 18/015,001

(22) PCT Filed: Jun. 30, 2021
(86) PCT No.: PCT/EP2021/068058

§ 371 Date: Jan. 6, 2023

(30) Foreign Application Priority Data
Jul. 8, 2020 (DE) 10 2020 004 116.7

(51) Int. Cl. G06Q 20/06; G06Q 20/38

(52) U.S. Cl. CPC G06Q 20/0655; G06Q 20/3823; G06Q 20/3825; G06Q 20/3829; G06Q 2220/00

(57) ABSTRACT

An issuing entity for issuing electronic coin data sets in a payment system, includes a coin generating unit, which is designed to generate an electronic coin data set, and a coin output unit, which is designed to obtain the electronic coin data set generated by the coin generating unit and output the electronic coin data set to a participating unit or to a bank entity of the payment system in electronic form. The issuing entity is designed such that the electronic coin data set is transmitted between the coin generating unit and the coin output unit via an air gap process. An issuing method and a payment system adopt features of the issuing entity.

### TECHNICAL FIELD OF THE INVENTION

The invention relates to an issuing entity and a method for issuing electronic coin data sets in a payment system and a payment system.

### TECHNICAL BACKGROUND OF THE INVENTION

Protection of privacy is an important value for society, especially when very sensitive data, such as payment information, is involved. Security of payment transactions and associated payment transaction data means protecting the confidentiality of the exchanged data; as well as protecting the integrity of the exchanged data; as well as protecting the availability of the exchanged data.

For electronic coin data sets, it must be possible to demonstrate basic control functions, in particular (1) detecting multiple-spending methods, also called double spending, and (2) detecting uncovered payments. In case (1), someone tries to spend the same coin data set multiple times, and in case (2), someone tries to spend a coin data set even though he has no credit (anymore).

In addition, the large number of transactions of an electronic coin data set and also the advancing lifespan increase the risk of manipulation(s) of the electronic coin data set.

In the future, it should be possible to dispense with cash (banknotes and analogue coins) altogether, or at least with analogue coins.

U.S. Pat. No. 5,872,844 A describes an electronic payment system. Electronic coin data sets (assets) are output in the system by a central entity. The electronic coin data sets are transmitted from a payer's terminal (wallet) to a payee's terminal. The payee's terminal routinely submits the transmitted coin data sets for a possible check. A fraud detection system takes samples of the coin data sets submitted for checking to discover “bad” coin data sets that have been used fraudulently. Upon such discovery, the fraud detection system identifies the terminal that used the bad coin data set and flags them as a “bad terminal”. The fraud detection system compiles a list of such bad terminals and distributes the list to warn other terminals of the bad terminals. If a bad terminal subsequently attempts to issue coin data sets (whether fraudulently or not), the intended recipient will check the list of bad terminals and will not execute a payment transaction with the bad terminal.

This known system is not anonymous, because a participant generates a pseudonym from an identity number, which must be used by the entity both for the payment transactions to the other participant and when generating and outputting the electronic coin data sets. The output electronic coin data sets also compulsorily comprise a signature string, which increases the storage requirement of the electronic coin data set per payment transaction, thus the electronic coin data set grows. Terminals that are not trustworthy are not approved at the system at all.

It is therefore the object of the present invention to create an issuing entity, a method, and a payment system in which a payment transaction between participants of a public payment system is designed in a secure, flexible, and simple way. In particular, a direct and anonymous payment between the participants of the payment system is to be created. The exchanged electronic coin data sets should be confidential to other system participants, but allow each system participant to perform basic checks on the electronic coin data set, namely (1) detecting multiple-spending attempts; (2) detecting attempts to pay with non-existent monetary values; and (3) detecting return criteria for already spent coin data sets, for example that an electronic coin data set should expire.

In particular, it is an object of the present invention to securely generate and issue electronic coin data sets to prevent an attacker from outputting coin data sets.

### SUMMARY OF THE INVENTION

In particular, the object is solved by an issuing entity for issuing electronic coin data sets in a payment system, with a coin generating unit configured for generating an electronic coin data set, and a coin output unit configured for obtaining the electronic coin data set generated by the coin generating unit and for outputting the electronic coin data set to a participating unit or a bank entity of the payment system in electronic form, wherein the issuing entity is configured such that the transmitting of the electronic coin data set between the coin generating unit and the coin output unit occurs via an air gap process.

This creates an electrical and/or electronic barrier between the coin generation and the coin output. The confidential units and data used for generation, for example a random number generator or one or more private key part(s), can thus remain in an offline operating environment and cannot be compromised by a network attack, also known as an online attacker. The security during generation of the coin data sets is thus enhanced.

An air gap or air wall (analogous to a “fire wall”) process here is a process that separates the two units (coin generating unit and coin output unit) from each other, but still permits the transmission of user data, in this case electronic coin data sets. An air gap process is used here to isolate the two differently trustworthy units from each other, but still ensure that data from the other unit can be processed.

In a preferred embodiment, the coin generating unit is designed without an electronic network interface and operates completely “offline”. All data fed to or taken from the coin generating unit is transmitted via secure electrical, electronical, and/or optical interfaces. None of these interfaces is connected to a network or another computer or terminal.

In a preferred embodiment, the coin generating unit could have an interface for maintenance or for obtaining an order input or for outputting status reports via the coin generating unit to another terminal.

In a preferred embodiment, the air gap process between the coin generating unit and the coin output unit is configured to physically, logically, electrically and/or electronically separate the coin generating unit from the coin output unit. Thus, both units are electro-technically isolated from each other in this regard. In other words: data transmission does not exclusively occur electrically/electronically. Thus, an attacker with network remote access to the coin output unit does not have access to the coin generating unit. It is therefore not possible for the attacker to introduce data into the coin generating unit and/or to tap data from the coin generating unit. This is due to the lack of a (permanent, physical) data connection (OSI layer 1) between the coin generating unit and the coin output unit.

In a preferred embodiment, the air gap process for obtaining the electronic coin data sets in the coin output unit comprises (at least partially) a physical transmission of the electronic coin data set between the coin generating unit and the coin output unit. The electronic coin data sets are in particular provided on a portable data carrier, which is transported (or physically transmitted) to the coin output unit. In one embodiment, physical transmission can be understood as an automated, semi-automated, or manual transmission—for example employing an operator—of a physically designed representative of the coin data set. In this embodiment, a physical representation of the electronic coin data set is transported by the operator between the coin generating unit and the coin output unit.

Alternatively or additionally, the physical transmission, for example of the portable data carriers with electronic coin data sets, takes place by means of a secured transport container. Lockable and/or mechanically stable metal boxes, such as those provided for banknote transport, can be used for this purpose. In one embodiment, the physical transmission takes place in a banknote transport box. This transmission by means of a transport box can in turn be (partially) automated in that a physical representation of the generated electronic coin data set is automatically filled into a transport box by the coin generating unit. This filled transport box is then transported to the coin output unit. There, the filled transport box is emptied and the physical representative of the coin data set is read in.

In a preferred embodiment, the transmitting takes place in the air gap process using portable electronic data storages, such as a USB stick, memory card, CD or similar. For this purpose, corresponding electronic interfaces, such as USB port, memory card reader or CD drive, are provided on the coin generating unit and the coin output unit.

In a preferred embodiment, the coin generating unit is further configured to create a printout (as a physical representative of an electronic coin data set) representing the electronic coin data set for transferring in the air gap process. The coin output unit is configured to read the coin data set printout generated by the coin generating unit. This is a comparatively simple form of implementing an air gap process. The printout can, for example, be transported to a reading region of the coin output unit via mechanical conveying mechanisms. The transport boxes already described can also be used for this purpose, so that, for example, a printout is automatically arranged in a transport box by the coin generating unit, then transported to the coin output unit, in particular its reading region, and read there.

The printout has at least one alphanumeric character string. An alphanumeric character is at least one letter of a given alphabet and the ten digits from 0 to 9. In a further sense, certain special characters may also be added. These characters form a string with which the coin data set is represented. The reading is then done, for example, manually or by optical character recognition (OCR) reading into the coin output unit.

The printout alternatively or additionally has at least one opto-electronically readable code, for example a two-dimensional code, such as a QR code, or a one-dimensional code, such as a barcode. A coin output unit-side reader, for example a barcode or QR code scanner, detects the electronic coin data set by scanning the printout.

Alternatively or additionally, the printout has at least one laser engraving, watermark and/or embossing. These techniques used in the production of value documents increase the security of the air gap-based transmission of the physical representatives (=printouts) of the electronic coin data sets.

In a preferred embodiment, the printout occurs on paper substrate or plastic substrate. The format of this substrate is, for example, a banknote format. In a preferred embodiment, printing is done on a security element-free substrate, for example white plain paper. Thus, the coin generating unit can be a part of a classical cash producing machine, for example a banknote producing machine. The printouts occur in the format of common banknote formats so that the banknote production machines do not have to be converted and an existing infrastructure can be used for generating electronic coin data sets as well.

In a preferred embodiment, the printout occurs on paper in DIN A4 format. Then a conventional printer can be used in the coin generating unit.

In a preferred embodiment, a plurality of different electronic coin data sets is represented on and arranged on one printout, for example on a DIN A4 page or a banknote format. This makes it practical to transmit multiple coin data sets simultaneously via the air gap process, making the transmission between the coin generating unit and the coin output unit much more efficient.

In a preferred embodiment, the coin output unit is a banknote processing machine. This allows the use of readers provided with banknote processing machines, such as scanners, to read the printouts. In addition, a data check can be employed to identify coin data sets that are already present in the payment system (duplicate coin data sets). In addition, a destruction of the printout can occur immediately, for example for each scanned printout or only selectively for certain printouts, as in the case of a detected duplicate coin data set. A destruction of the printout can occur, for example, by shredding, punching, burning or by sorting-out and shredding/burning/punching/ . . . .

Preferably, the coin output unit has a reader (scanner) for opto-electronically reading the printout. This makes it easier to read barcodes and QR codes or alphanumeric character strings.

After the transmitting by means of the air gap process, the generated coin data sets are (again) available in electronic form and can be used in the payment system, in particular after they have been issued.

Preferably, the coin generating unit has a reader (scanner) for opto-electronically reading a generation request. Thus, an electronic interface for receiving the generation request can be dispensed with and an attacker has fewer possibilities to manipulate the generation of the electronic coin data sets.

In a preferred embodiment, the coin output unit has a checking device for checking the printout. The checking device or checking unit of the coin output unit is used for identification of invalid coin data sets (invalid printouts), for example coin data sets that already exist in the payment system or defective coin data sets.

In one embodiment, a printout destruction unit is provided in the coin output unit for destroying coin data sets (printouts). Preferably, either all printouts or selectively only certain printouts, such as invalid coin data sets, are destroyed. Invalid coin data sets (printouts) are for example unreadable printouts or detected duplicate electronic coin data sets (represented by the printouts). A destruction unit is, for example, a mechanical fragmentation device (shredder) with which the printouts are physically fragmented and destroyed as a result. In another example, the printouts are burned (and optionally marked as invalid beforehand) in the printout destruction unit. In addition, the destruction unit may include a sort-out compartment in which the printouts to be destroyed are temporarily stored. Such destruction units could be destruction units of banknote processing machines.

Only successfully checked electronic coin data sets leave the coin output unit. Coin data sets that are not checked or coin data sets that have been checked as invalid do not leave the issuing entity. A check can be checked, for example, on the basis of metadata or register data from a database of the payment system to which the coin output unit has access. For example, serial numbers, a coin identifier or similar data elements can be checked for duplicate presence in the payment system.

In a preferred embodiment, the coin generating unit is further configured for generating metadata about the electronic coin data set. The coin output unit is further configured for obtaining the metadata, wherein the issuing entity is configured such that the transmitting of the metadata between the coin generating unit and the coin output unit occurs via the air gap process. The transmission of metadata may occur in parallel with or after the transmission of coin data sets between the coin generating unit and the coin output unit. A printout could comprise both the metadata and the associated coin data sets.

The metadata here is structured data that contain features about at least one electronic coin data set, for example a coin identifier (such as serial number), a denomination and/or a quantity (per printout or time unit) of generated electronic coin data sets.

In a preferred embodiment, the coin generating unit is further configured for signing the electronic coin data set with a private cryptographic key(part) of the issuing entity. The generated electronic coin data set may have the electronic coin data set and the signature. The electronic coin data set with its (coin data set) signature is transmitted and output. This allows any participating unit and/or bank entity in possession of the coin data set and the issuing entity's public key(s) to check the coin data set for validity, in particular whether it was issued by a trustworthy entity (the issuing entity).

Asymmetric cryptographic systems—such as for example RSA, Rabin, ElGamal or elliptic curves—with key pairs that comprise a public and a secret key (part) are well known. In addition to an issuer key pair for generating signatures for the electronic coin data sets, the issuing entity can have further key pairs, which can furthermore use different cryptographic systems.

In preferred embodiments, the coin generating unit may be configured for generating issuer security data. An issuer signature generated with a private issuer key part is only one example of issuer security data. The issuer security data may also be generated by other means, such as symmetric keys, predetermined pseudo-random number sequences (such as OTP generators), XOR operations or other cryptographic means. The coin output unit receives both the electronic coin data set and the generated issuer security data from the coin generating unit via the air gap process.

Usually, the coin generating unit is further configured for generating a register data set which is intended for storage in a coin register of the payment system. Preferably, the coin output unit also obtains the generated register data set from the coin generating unit via the air gap process, thus in particular the electronic coin data set and the register data set. All valid coins are registered in the coin register of the payment system, preferably with their masked coin data set. Generating the register data set therefore typically comprises at least generating a masked coin data set by applying a homomorphic one-way function to the electronic coin data set.

The coin output unit is preferably configured for registering the electronic coin data set in the coin register by outputting the register data set and the issuer security data to the coin register. The issuing of an electronic coin data set by the issuing entity thus comprises both the outputting of the electronic coin data set to the participant or the bank entity and a registering in the coin register. The register data set can comprise the issuer security data for storage in the coin register. The register data set is stored in the coin register together with the issuer security data contained therein. Alternatively, the issuer security data is output in addition to the register data set to be stored. The coin register checks the issuer security data and stores the register data set (only if the check is successful). The registering in the coin register occurs preferably also by the issuing entity. However, it is conceivable to output the issuer security data (and the register data set) to the participant or the bank entity together with the electronic coin data set, which then sends the issuer security data (and the register data set) to the coin register.

A register data set may have one or more of the following data elements:

a masked electronic coin data set (Z), in particular generated by applying a homomorphic one-way function (f(C)) to the electronic coin data set(C);
a signature as issuer security data, in particular as signature of the electronic coin data set (C), of the register data set (RDS) and/or of a masked electronic coin data set (Z);
a range proof of the electronic coin data set (C); a check value (pᵢ) regarding the electronic coin data set (C); and/or a monetary amount (v) of the electronic coin data set (C).

In a particularly preferred embodiment, the coin generating unit is configured for signing the register data set, in particular of at least one masked electronic coin data set, with a private cryptographic key part of the issuing entity. The private cryptographic key part of the coin generating unit can be a private register data set key part, which in particular would be independent of further keys, such as a possible private coin data set key part of the coin generating unit or an authentication key of the coin output unit. This allows a coin register (and also any other participant) of the payment system in possession of the (masked) coin data set and the public key to check the validity of the masked coin data set, in particular whether it has been issued by a trustworthy entity (the issuing entity).

The coin output unit will advantageously both authenticate itself to a coin register, in particular by means of an authentication key of the coin output unit, and output the issuer security data to the coin register. The coin register can thus first check the permission of the coin output unit before subsequently (only after successful authentication) checking the correctness of the issuer security data. The issuer security data can in particular be designed as a signature of the register data set and/or a masked electronic coin data set. Advantageously, the coin output unit can comprise a hardware security module, HSM, which stores the authentication key.

Preferably, the coin output unit has a storage unit in which the generated electronic coin data sets are stored. The generated electronic coin data sets can then be issued on request by a participating unit or by a bank entity. The generation of the electronic coin data sets is then temporally uncorrelated with the output of the electronic coin data set to the participating unit and/or the bank entity. This means that a coin data set is promptly provided by the issuing entity in response to a request, which increases user acceptance in the payment system. The associated register data sets may have already been stored in the coin register when the coin data sets were stored in the storage unit (coin store) at the register request of the issuing entity.

In a preferred embodiment, the coin output unit is further arranged to receive a deactivating request from a participating unit or a bank entity regarding a generated electronic coin data set, wherein the coin output unit is further configured to send a deactivating request to a coin register regarding a deleting of a register data set. This allows the issuing entity (as the only entity in the payment system) to deactivate a coin data set, for example to delete or recoin or mark it as invalid. The issuing entity can cause a commercial bank to convert the monetary value of a coin data set that has been deactivated/is to be deactivated into book money, for example, to credit a participant's account, or to output cash in a cash output tray of the coin output unit.

In a further aspect of the invention, a method for issuing an electronic coin data set by an issuing entity of a payment method comprising the following method steps is provided: Generating an electronic coin data set in a coin generating unit of the issuing entity; transmitting the generated electronic coin data set between the coin generating unit and a coin output unit of the issuing entity via an air gap process for obtaining the generated electronic coin data set in the coin output unit; and outputting the electronic coin data set to a participating unit or a bank entity of the payment system in electronic form.

Preferably, the method further comprises generating a register data set in the coin generating unit of the issuing entity; transmitting the generated electronic coin data set and the register data set between the coin generating unit and the coin output unit of the issuing entity via the air gap process for obtaining the generated electronic coin data set and the register data set in the coin output unit; and outputting the register data set to a coin register of the payment system for registering the electronic coin data set in the coin register.

In a preferred embodiment, the method further comprises signing the register data set with a private cryptographic key part of the issuing entity; transmitting the generated electronic coin data set, the register data set, and the signature between the coin generating unit and the coin output unit of the issuing entity via the air gap process for obtaining the generated electronic coin data set, the register data set and the signature in the coin output unit; and outputting the register data set and the signature to the coin register of the payment system for checking and/or storing the signature of the register data set in the coin register. Thus, the signature is only checked and not stored in the coin register, checked and then stored with the register data record or as part of the register data record, or possibly even stored unchecked. Preferably, the air gap process is a physical or transport container-secured transmitting of a physical representative of the electronic coin data set. Preferably, the air gap process comprises the use of a portable data carrier, preferably a portable electronic data storage.

Preferably, the air gap process comprises creating a printout representing the generated electronic coin data set in the coin generating unit and reading the printout by the coin output unit for obtaining the electronic coin data set generated by the coin generating unit.

The method preferably further comprises receiving, in the coin output unit, a deactivating request from a participating unit or a bank entity regarding a generated electronic coin data set; and/or sending, from the coin output unit, a deactivating request to a coin register regarding a deleting of a register data set.

In one aspect of the invention, the object is solved by a payment system for paying with electronic coin data sets. The payment system is provided, inter alia, with a coin register configured for registering the electronic coin data sets; with participating units configured for executing payment transactions by transmitting the electronic coin data sets and for sending status and/or registration requests regarding the electronic coin data sets; and with an issuing entity (previously described).

Preferably, the coin register is configured for registering an electronic coin data set output by the issuing entity, in particular when an issuer security value is present for or in a register data set to be stored in the coin register. Further preferably, the coin register is further configured to register an electronic coin data set modified by a participating unit or a bank entity only when it is a modification of an already registered coin data set. In the register, the (at least one) modified electronic coin data set replaces the (at least one) already registered coin data set. An electronic coin data set is registered in the coin register in the form of a masked electronic coin data set.

Participating units or bank entities can send a status request to the coin register to find out whether the electronic coin data set is valid (thus registered as valid in the coin register). Participating units or bank entities can generate (at least) one modified electronic coin data set from (at least) one electronic coin data set, for example by rewriting, splitting or merging electronic coin data sets. Participating units or bank entities register their modified coin data set in the coin register via a registration request to the coin register.

Preferably, an electronic coin data set is masked by applying a homomorphic one-way function to the electronic coin data set so that a masked electronic coin data set is obtained that serves as a register data set or part of the register data set. The masked electronic coin data set is registered in the coin register of the payment system. Preferably, the registering for an output electronic coin data set of the issuer occurs as an initial registration. The new coin data set is generated without adjusting the already registered coin data sets. A modification registration occurs for an electronic coin data set modified by a participant unit or a bank entity. The modified coin data set replaces (in a neutral amount) a coin data set previously registered as valid.

Preferably, an electronic coin data set is masked by applying a homomorphic one-way function to the electronic coin data set by a participating unit to obtain a masked electronic coin data set as a register data set, wherein the masked electronic coin data set is registered in the coin register of the payment system.

An electronic coin data set is in particular an electronic data set that represents a monetary value (=having a value of money) and is also colloquially referred to as a “digital coin” or “electronic coin”. This monetary amount can exchange from a first terminal to another terminal during the method. In the following, a monetary amount (asset) is understood as a digital amount that can be credited to an account of a financial institution, for example, or can be exchanged for another means of payment. An electronic coin data set thus represents cash in electronic form.

An electronic coin data set for transmitting monetary amounts differs substantially from the electronic data set for data exchange or data transfer, for example a register data set, since a classic data transaction takes place on the basis of a question-answer principle or on an intercommunication between the data transfer partners, for example the participating unit and one of the register entities (coin register, monitoring register, transaction register). In the course of authentication, identification or identifier data can be exchanged, which can lead to conclusions about a participant identifier and/or an identification number of a natural person as a user (participant) of the payment system. This means that anonymous payment is not possible. An electronic coin data set, on the other hand, is anonymous, unique, unambiguous and is in the context of a security concept. In principle, an electronic coin data set contains all data elements required for a receiving entity. In contrast to the copying of electronic data sets, thus the duplication of digital data, a valid electronic coin data set may only exist once in the payment system. This system requirement must be observed in particular when transmitting electronic coin data sets.

In an advantageous embodiment, the electronic coin data set has as a data element a monetary amount, thus a datum representing a monetary amount of the electronic coin data set, and as a data element an obfuscation amount, for example a random number. The obfuscation amount is not known to the coin register. The obfuscation amount is a secret data element, except in the first layer (direct transaction layer). An electronic coin data set is unambiguously represented by these at least two data elements (monetary amount, obfuscation amount). Anyone who has access to these data elements of an electronic coin data set can use this electronic coin data set for payment in a payment transaction. Knowing these two data elements (monetary amount, obfuscation amount) is therefore equivalent to owning the digital money. This electronic coin data set can be transmitted directly between two participating units. To exchange digital money (=payment transaction), only the transmission of the monetary amount and the obfuscation amount is necessary.

In one embodiment, each electronic coin data set also has at least a check value as a data element, so that it then consists of at least three data (monetary amount, obfuscation amount, check value). The function of the check value of the electronic coin data set will be explained later. In one embodiment, each electronic coin data set may have a coin identifier as a data element, the coin identifier preferably becoming the identification of a register data set regarding the electronic coin data set. A coin identifier is a data element for unambiguously associating the electronic coin data set in the payment system. This coin identifier is preferably a random number. The coin identifier (if trackable) provides information about the life cycle of an electronic coin data set.

In addition, the electronic coin data set may have further data elements, for example which currency the monetary amount represents, by which issuing entity it was generated and/or a signature of an issuing entity.

In order to make a transmission protocol secure, the electronic coin data sets are managed by respective participating units, such as by security elements integrated there, and are also transmitted by them. In a preferred embodiment, the security element is operationally integrated into the participating unit. The participating unit can include an application through which a user (=participant) controls a payment process and accesses electronic coin data sets of the security element in this payment process.

The participating unit can be, for example, a mobile terminal such as, for example, a smartphone, a tablet computer, a computer, a server or a machine. A transmitting of the electronic coin data set from the (first) security element of a first participating unit occurs, for example, to the (second) security element of another participating unit. A participating-unit-to-participating-unit transmission path can be set up, via which, for example, a secure channel is established between the two security elements, via which the transmitting of the electronic coin data set then occurs. An operationally integrated application (installed) on the participating unit can initiate and control the transmission of the coin data set by using input and/or output means of the respective participating unit. For example, amounts of electronic coin data sets can be displayed and the transmission process can be monitored.

A new electronic coin data set, unlike a register data set, cannot be generated by a participating unit or the coin register. The generating of an electronic coin data set (and also its destruction or deletion) occurs by the issuing entity of the payment system, preferably exclusively by the issuing entity of the payment system.

In a preferred embodiment, a security element is operationally integrated into a participating unit. This ensures that register data records are generated and encrypted and, if necessary, also sent without tampering. In one embodiment, the register data set is created in the security element and then sent to the coin register by the participating unit.

A security element is a technical resource-limited device. A security element is, for example, a special computer program product, in particular in the form of a secure runtime environment within an operating system of a terminal, Trusted Execution Environments, TEE, or eSIM software, stored on a data storage, for example of a participating unit, such as a (mobile) terminal, a machine or an automated teller machine. Alternatively or additionally, the security element is designed, for example, as special hardware, in particular in the form of a secure hardware platform module, Trusted Platform Module, TPM, or as a smart card or an embedded security module, eUICC, eSIM. The security element provides a trusted environment and thus has a higher level of trust than a terminal in which the security element may be operationally integrated. The transmitting of an electronic coin data set occurs preferably between two security elements to create a trustworthy environment. In this case, the logical transmission of the electronic coin data set is direct, whereas a physical transmission may have one or more intermediate entities, for example one or more participating units for making the security element(s) operational and/or a remote data storage service where a wallet application with electronic coin data sets is physically stored.

Security elements can transmit electronic coin data sets between each other and then continue to use them directly—without register check(s)—in particular if the payment system assumes that electronic coin data sets of security elements are per se considered valid.

One or more electronic coin data sets may be securely stored in a participating unit or security element, for example, a plurality of electronic coin data sets may be securely stored in a data storage exclusively associated with a participating unit or security element. The data storage then represents, for example, an electronic wallet application. This data memory can be internal, external, or virtual to the security element, for example.

The first security element could also have obtained electronic coin data sets from less trustworthy entities, such as participating units, thus a terminal or a machine, for example via an import/export function of the security element. Such received electronic coin data sets that were not obtained directly from another security element are considered less trustworthy. It could be a requirement of the payment system to check such electronic coin data sets for validity by the coin register or by an action (modification) by the receiving security element to rewrite the electronic coin data set to the receiving security element before it is allowed to be forwarded.

A transmission of the electronic coin data set between the first and the second security element may be integrated in a transmission protocol between two participating units and/or integrated in a secure channel between two applications of the respective participating unit. In addition, the transmission may include an internet data connection to an external data storage, for example an online storage.

The electronic coin data set (to be transmitted or modified) is registered in a coin register of the payment system. This means, for example, that a communication connection to the coin data set is provided for registering the electronic coin data set. This communication connection does not necessarily have to be present during the transmission process (payment process). Preferably, the coin register is provided for the managing and check of masked electronic coin data sets. The coin register can also manage and check further (non-payment) transactions between participating units.

The coin register—as part of the second layer—is, for example, a database in which a register data set is generated and/or stored. A register data set is a data set that makes it possible to know and/or verify the validity, status, history and/or whereabouts of an electronic coin data set. A register data set is preferably unambiguously associated with an electronic coin data set. The register data set is for checking purposes only and cannot be used to replace the electronic coin data set for payment transactions.

A register data set has one or more of the following data elements: an electronic coin data set signature; an electronic coin data set range proof; an electronic coin data set check value; a check value regarding the electronic coin data set; a counter value regarding the electronic coin data set; a participant identifier of a participating unit sending the register data set; a masked electronic coin data set; and/or a monetary amount of the electronic coin data set. All of these data elements and their function are defined at the appropriate locations.

In a preferred embodiment, the coin register provides a register data set. For example, the register data set has, as a data element, a masked electronic coin data set corresponding to an electronic coin data set. The masked electronic coin data set has been provided, for example, by a participating unit or an issuing entity. Possession of a masked electronic coin data set does not permit disclosure of data elements of the (corresponding) electronic coin data set, making such a register data set with (only) masked coin data sets anonymous with respect to a participant identifier and also anonymous with respect to a monetary amount of the electronic coin data set. Masking is explained later.

In a further embodiment, the register data set has, for example, as data elements a masked electronic coin data set and an amount category regarding a monetary amount of the electronic coin data set corresponding to the masked electronic coin data set. Such a register data set with a masked coin data set is identity-anonymous and amount-pseudonymous. Masking and also the use of amount categories will be explained later.

In a further embodiment, the register data set has, for example, as data elements a coin identifier of an electronic coin data set, a check value of the electronic coin data set and a pseudonym of the participant identifier. Such a register data set is identity-pseudonymous and amount-anonymous.

For example, masked electronic coin data sets are provided as a data element in the register data set or as the register data set. These masked electronic coin data sets are registered with their corresponding processing in the coin register. Masking will be explained later. In a preferred embodiment, a validity status of the (masked) electronic coin data set can be derived therefrom. Preferably, the validity of the (masked) electronic coin data set is noted (registered) in the coin register. Modifications, such as switching, splitting or combining, to the individual electronic coin data sets are registered in the coin register.

The registration of the processing or the processing steps for a respective modification in the coin register may, in one embodiment of the payment system, also concern the registration of check results and intermediate check results regarding the validity of an electronic coin data set in the coin register, in particular determining check values and counter values of corresponding electronic coin data sets. If a processing is final, this is indicated, for example, by corresponding marking or a derived overall marking in the coin register. Final processing then decides whether an electronic coin data set is valid or invalid.

The coin register can, for example, be a decentralised public database. This database makes it easy to check the validity of electronic coin data sets and to prevent double spending without registering or logging the transmitting itself. The database, for example a distributed ledger technology, DLT, describes a technique for networked computers to agree on the order of certain transactions and that these transactions update data. It corresponds to a decentrally maintained management system or a decentrally maintained database.

Alternatively, the coin register is a centrally maintained database, for example in the form of a publicly accessible data storage or as a mixed form of centralised and decentralised database. For example, the coin register and the monitoring register are designed as a services server of the payment system.

In a preferred embodiment, a corresponding masked electronic coin data set is associated with each electronic coin data set in the respective method. Knowledge of a masked electronic coin data set does not authorise to spend the digital money represented by the electronic coin data set. This represents a substantial difference between masked electronic coin data sets and (non-masked) electronic coin data sets. A masked electronic coin data set is unique and also unambiguously associable to an electronic coin data set, so there is a 1-to-1 relationship between a masked electronic coin data set and a (non-masked) electronic coin data set. The masking of the electronic coin data set is preferably performed by a computing unit of the participating unit. The participating unit has at least one electronic coin data set. Alternatively, masking may be performed by a computing unit of a participating unit receiving the electronic coin data set.

This masked electronic coin data set is obtained by applying a homomorphic one-way function, in particular a homomorphic cryptographic function. This function is a one-way function, thus a mathematical function that is “easy” to calculate in terms of complexity theory, but “difficult” to practically impossible to reverse. In this context, one-way function also refers to a function for which no inversion is known that can be practically executed in a reasonable amount of time and with a reasonable amount of effort. Thus, the calculation of a masked electronic coin data set from an electronic coin data set is comparable to the generation of a public key in an encryption procedure via a residue class group. Preferably, a one-way function is used that operates on a group in which the discrete logarithm problem is difficult to solve, such as a cryptographic process analogous to elliptic curve encryption, or ECC, from a private key of a corresponding cryptographic method. The reverse function, thus the generation of an electronic coin data set from a masked electronic coin data set, is thereby—equivalent to the generation of the private key from a public key in an encryption method over a residue class group—very time-consuming. When the present document refers to sums and differences or other mathematical operations, the respective operations on the corresponding mathematical group are to be understood in the mathematical sense, for example the group of points on an elliptical curve.

The one-way function is homomorphic, thus a cryptographic process that has homomorphic properties. This means that mathematical operations can be performed on the masked electronic coin data set that can also be performed in parallel on the (non-masked) electronic coin data set and thus be reproduced. Using the homomorphic one-way function, calculations with masked electronic coin data sets can be retraced in the coin register and/or the monitoring register without the corresponding (non-masked) electronic coin data sets being known there. Therefore, certain calculations with electronic coin data sets, for example for a processing of the (non-masked) electronic coin data set (for example splitting or merging), can also be proven in parallel with the corresponding masked electronic coin data sets in the coin register, for example for validation checks (=validities). In addition, the monitoring of the legitimacy of the respective electronic coin data set can be proven in the monitoring register in parallel. The homomorphism properties apply at least to addition and subtraction operations, so that switching, splitting or combining (=merging) of electronic coin data sets can also be performed by means of the correspondingly masked electronic coin data sets in the coin register or the monitoring register or the check whether the electronic coin data set is to be returned (deleted) or reminted is recorded in the monitoring register and can be retraced by requesting participating units or their security elements and/or by the coin register and/or by the monitoring register without gaining knowledge of the monetary amount and the performing participating unit.

The homomorphism property thus enables an entry of valid and invalid electronic coin data sets on the basis of their masked electronic coin data sets in a coin register and a monitoring register without knowledge of the electronic coin data sets, even if these electronic coin data sets are processed (split, merged, switched) or transmitted directly, thus an action is performed with these electronic coin data sets. This always ensures that no additional monetary amount has been created or that an identity of the participating units or their security elements is recorded in the coin register or the monitoring register. Masking allows a high level of security without giving any insight into the monetary amount or the participating unit.

When transmitting an electronic coin data set directly from the first participating unit to a second participating unit, two participating units simultaneously have knowledge of the electronic coin data set to be transmitted. It must be prevented that the sending first participating unit also uses the electronic coin data set at another (third) participating unit for payment (so-called double spending). Before transmitting, a status of the electronic coin data set can therefore be set to inactive status in order to invalidate the electronic coin data set, then the sending (as a first step of transmitting) to the second participating unit occurs and, if there is an acknowledgement of receipt from the second participating unit, deleting of the electronic coin data set in the first participating unit occurs (as a second step of transmitting). An acknowledgement of deletion from the first participating unit can be sent to the coin register or the second participating unit to indicate a successful deletion (performed in the first participating unit) of the electronic coin data set.

In addition, the transmitted electronic coin data set can be switched from the first participating unit to a second participating unit. The switching can preferably take place automatically upon receiving the acknowledgement of deletion of an electronic coin data set in the second participating unit. In addition, it may also occur upon receiving, for example, a command from the first participating unit and/or the second participating unit. Additionally, an electronic coin data set can also be divided (=split) into at least two electronic coin data subsets. In addition, two electronic coin data sets can be merged into one electronic coin data set.

The switching, splitting and merging are different modifications to an electronic coin data set, thus actions with the electronic coin data set. These modifications require registering the masked coin data set in the coin register of the payment system. The actual performing of the individual modifications will be explained later.

Switching also occurs when an electronic coin data set has been modified, for example split or merged with other electronic coin data sets, in particular to be able to settle a monetary amount to be paid appropriately. The payment system should in this case always be able to pay any monetary amount.

The following explains detecting of return criteria for coin data sets that have already been output, for example that a coin data set should expire:

The electronic coin data sets are output by a central issuing entity, wherein each electronic coin data set also has a check value. The check value is invariant to an action (modification) performed by participating units on the electronic coin data set. The method comprises the following step of: Determining, by the participating unit, on the basis of the check value of the electronic coin data set whether the electronic coin data set is returned to the central issuing entity. Thus, in a preferred embodiment, for the detecting of return criteria, it is also determined, on the basis of the above mentioned check value for unsent transaction data sets or on the basis of a further check value, whether the electronic coin data set is notified by the first participating unit to the payment system, in particular to a coin register, and/or whether the electronic coin data set is returned to the central issuing entity.

Each check value of the electronic coin data set is used in the method to enable or enhance a control function in the payment system. Each check value is preferably a data element of the electronic coin data set that can be read by the participating unit or a data element in the participating unit and its value can be determined by the participating unit. The check value for the return criteria is coupled to an electronic coin data set.

The check value is invariant in case of an action performed by participating units with the electronic coin data set (action invariant). Action invariant means that when an action is performed with the coin data set, the check value remains unchanged. The action invariant check value is not individual to the electronic coin data set, but group specific and therefore applies to a plurality of different coin data sets to maintain anonymity and prevent coin data set tracking. An action with a coin data set is deemed any modification performed by a terminal on the coin data set, thus in particular switching, splitting, combining, as will be described later. In addition, any transmitting of the coin data set, for example to a (different) participating unit or also to an entity in the payment system, is meant as an action. In addition, redeeming the coin data set to credit a monetary amount of the coin data set or changing the currency system is meant as an action. These actions are performed by participating units and do not change the check value.

On the basis of the check value of the electronic coin data set by the participating unit, it is determined whether the electronic coin data set is returned to the central issuing entity. Thus, the check value can be used to define a criterion for the return of an electronic coin data set. In this way, electronic coin data sets can expire, for example, based on their lifetime or the number of actions performed with the coin data set, in order to increase security at the payment system.

In a preferred embodiment, the electronic coin data set is returned to the central issuing entity by the payment system following a notificating. Thus, by the notificating at the payment system, it is determined in the payment system whether the coin data set is to be returned. In this embodiment, the determining whether a return has to occur is performed in the payment system instead of the participating unit. The result of the determining is communicated to the participating unit and the participating unit is requested by the payment system to return the electronic coin data set.

In a preferred embodiment, a counter value in the payment system (the monitoring register) regarding this electronic coin data set is determined by the payment system as a result of the notificating, using the check value of the electronic coin data set. The coin data set check value is preferably transmitted from the participating unit to the payment system (the monitoring register). The counter value is in this process not part of the coin data set. Preferably, the counter value is managed in the payment system. Preferably, the counter value is increased with each action (modification, transmission, redemption) regarding the electronic coin data set. Preferably, the counter value is increased with different weighting for different actions. This makes it possible to control the return in an improved way according to different actions. Thus, in the coin data set, the check value is provided as a data element that is incremented in particular with each direct transmission between participating units. The counter value in the payment system involves the check value, for example by adding the previous counter value to the check value.

On the basis of the check value of the electronic coin data set, it is determined whether the electronic coin data set is returned to the central issuing entity. Preferably, the check value is invariant upon an action performed by participating units with the electronic coin data set, wherein preferably the check value is at least a value from the following list: return date of the electronic coin data set; output date of the electronic coin data set; registration date of the electronic coin data set; and identification value of the electronic coin data set. The action invariant check value is not individual to the electronic coin data set but is group specific and therefore applies to a plurality of different coin data sets to maintain anonymity and prevent coin data set tracking. The action invariant check value is not individual to the electronic coin data set in this process but applies to a plurality of different coin data sets (group ID) to maintain anonymity and prevent coin data set tracking.

In an advantageous embodiment, the check value is variable to determine whether the electronic coin data set is returned. A sum could be formed in this process and this sum could be compared to a predefined threshold value. For example, the number of direct transmissions could be a return criterion, so that no infrastructure for evaluation of the coin data sets with regard to the return of the coin data set would have to be maintained in the payment system, thus enabling a simpler and more secure management while creating the control functions.

In an advantageous embodiment, the exceeding of a blocking threshold value of the check value of the electronic coin data set is detected by a first participating unit and an action with this electronic coin data set, in particular the direct transmission of this electronic coin data set from the first participating unit to a second participating unit, is blocked, irrespective of whether another electronic coin data set is present in the first participating unit or not. Thus, a threshold value is defined, which, when reached, fully prevents (blocks) direct forwarding (transmitting) between participating units. For example, this coin data set could be stored in a secure storage area that can only be accessed by a return process but not by an action process of the participating unit.

The threat of blocking can be detected in advance by the participating unit and communicated to a user of the participating unit to stop the coin data set from blocking by immediately returning the coin data set. Additionally or alternatively, the participating unit may return the electronic coin data set upon detecting the exceeding of the blocking threshold value.

Preferably, the threshold value of the check value is lower than the blocking threshold value of the check value. The blocking threshold value can be a multiple of the threshold value in order not to block the coin data set too early. The threshold value is for example ten, or for example five, or for example 3. The blocking threshold value is correspondingly 30, or for example 15, or for example 10.

In a preferred embodiment, the issuing entity queries coin data set check values at predefined periodic intervals or in a targeted manner and automatically reclaims an electronic coin data set when a coin data set check value is exceeded.

In a preferred embodiment of the return process, the payment system's monitoring register determines a counter value in the monitoring register regarding the electronic coin data set using the check value of the electronic coin data set. If a threshold value of the counter value is exceeded, the electronic coin data set is returned (directly or indirectly) to the central issuing entity. The issuing entity or the payment system requests the corresponding coin data set from the participating unit or provides a corresponding information from the payment system to the participating unit for (direct) return. The counter value is preferably increased with each action on the electronic coin data set, whereby preferably for different actions the counter value is increased with different weighting. Reference is made to the above advantages in such a method.

In a preferred embodiment of the return method, upon performing an action on the electronic coin data set by the monitoring register, the check value of the electronic coin data set is reset by the payment system. This simplifies the method as the participating unit does not have to be adapted to the sum of all allowed actions, but only to the sum of successively allowed direct transmissions. In a preferred embodiment, when combining (=merging) electronic coin data sets into a combined electronic coin data set, the payment system determines the highest check value of the electronic coin data sets and adopts this highest check value as the check value of the combined electronic coin data set.

In a preferred embodiment, when combining electronic coin data sets into a combined electronic coin data set, a new check value is determined by the monitoring register from the sum of all check values of the electronic coin data sets divided by the product of the number of coin data sets with a constant correction value, wherein said new check value is adopted as the check value of the combined electronic coin data set, wherein said correction value is greater than or equal to 1, and wherein preferably said correction value depends on a maximum deviation of the individual check values of the electronic coin data sets or on a maximum check value of one of the electronic coin data sets, wherein further preferably said correction value is smaller than or equal to 2. The correction value is constant throughout the payment system.

In a preferred embodiment, the returning of the electronic coin data set to the issuing entity occurs when the terminal initiates the redeeming of a monetary amount of the electronic coin data set to an account of the payment system and/or when the participant unit requests an exchange of the monetary amount of the electronic coin data set to another currency system of the payment system.

An electronic coin data set can be split in a participating unit and this splitting is subsequently registered in the coin register. This has the advantage that an owner of at least one electronic coin data set is not forced to always transmit the entire monetary amount at once, but to now form and transmit corresponding partial monetary amounts. The monetary amount can be split symmetrically or asymmetrically without restrictions as long as all electronic coin data subsets have a positive monetary amount that is smaller than the monetary amount of the electronic coin data set from which it is split and the sum of the electronic coin data subsets is equal to the electronic coin data subset to be split. Alternatively or additionally, fixed denominations can be employed. The split into partial amounts is arbitrary. The splitting triggers, for example, the executing of the method described above for generating and encrypting a transaction data set, and the masked split electronic coin data subset may be part of a transaction data set for the transaction register.

The method preferably comprises the further following steps of: Switching the transmitted electronic coin data subset; and/or merging the transmitted electronic coin data set with a second electronic coin data set to form a (new) merged electronic coin data set.

When switching, the electronic coin data subset obtained from the first participating unit results in a new electronic coin data set, preferably with the same monetary amount, called the electronic coin data set to be switched. The new electronic coin data set is generated by the second participating unit, preferably by using the monetary amount of the obtained electronic coin data set as the monetary amount of the electronic coin data set to be switched. In doing so, a new obfuscation amount, for example a random number, is generated. The new obfuscation amount is added to the obfuscation amount of the obtained electronic coin data set, for example, so that the sum of both obfuscation amounts (new and obtained) serves as the obfuscation amount of the electronic coin data set to be switched. After switching, the obtained electronic coin data subset and the electronic coin data subset to be switched are preferably masked in the participating unit by applying the homomorphic one-way function to the received electronic coin data subset and the electronic coin data subset to be switched, respectively, to obtain a masked received electronic coin data subset and a masked switched electronic coin data subset. The switching triggers, for example, the executing of the method described above for generating and encrypting a transaction record, and the masked electronic coin data subset to be switched may be part of a transaction data set for the transaction register.

The switching is thus secured by adding a new obfuscation amount to the obfuscation amount of the obtained electronic coin data set, thus obtaining an obfuscation amount that only the second participating unit knows. Newly created obfuscation amounts must have a high entropy, as they are used as a blinding factor for the corresponding masked electronic coin data subsets. Preferably, a random number generator on the security element is used for this purpose. This security can be tracked in the coin register.

Preferably, as part of the switching, additional information required for registering the switching of the masked electronic coin data set in the coin register is calculated in the participating unit. Preferably, the additional information includes a range proof of the masked electronic coin data set to be switched and a range proof of the masked obtained electronic coin data set. The range proof is a proof that the monetary amount of the electronic coin data set is non-negative, the electronic coin data set is validly created, and/or the monetary amount and the obfuscation amount of the electronic coin data set are known to the creator of the range proof. In particular, the range proof is used to provide such proof(s) without revealing the monetary amount and/or the obfuscation amount of the masked electronic coin data set. These range proofs are also called “zero-knowledge range proofs”. It is preferred that ring signatures are used as range proof. Subsequently, a registration of the switching of the masked electronic coin data set occurs in the remote coin register. The registering triggers, for example, the executing of the method described above for generating and encrypting a transaction data set, and the masked electronic coin data subset to be switched may be part of a transaction data set for the transaction register.

The step of registering is preferably executed when the second participating unit is connected to the coin register. While the electronic coin data sets are used for direct payment between two participating units, the masked coin data sets can be registered with a pseudonym in the coin register. The registering triggers, for example, the executing of the method described above for generating and encrypting a transaction data set, and the pseudonymized masked electronic coin data subset to be switched may be part of a transaction data set for the transaction register.

In a further preferred embodiment of the method, for merging electronic coin data subsets, a further electronic coin data set (merged electronic coin data set) is created from a first and a second electronic coin data subset. Thereby, the obfuscation amount for the electronic coin data set to be merged is calculated by forming the sum of the respective obfuscation amounts of the first and the second electronic coin data sets. Furthermore, preferably the monetary amount for the merged electronic coin data set is calculated by forming the sum of the respective monetary amounts of the first and second electronic coin data sets.

After the merging, the first electronic coin data subset, the second electronic coin data subset, and the electronic coin data set to be merged are masked in the (first and/or second) participating unit by applying the homomorphic one-way function to each of the first electronic coin data subset, the second electronic coin data subset, and the electronic coin data set to be merged, respectively, to obtain a masked first electronic coin data subset, a masked second electronic coin data subset, as well as a masked electronic coin data set to be merged, respectively. Further, additional information required to register the merging of the masked electronic coin data sets in the remote coin register is calculated in the participating unit. Preferably, the additional information includes a range proof over the masked first electronic coin data subset and a range proof over the masked second electronic coin data subset. The range proof is a proof that the monetary amount of the electronic coin data set is non-negative, the electronic coin data set is validly created and/or the monetary amount and the obfuscation amount of the electronic coin data set are known to the creator of the range proof. In particular, the range proof is used to provide such proof(s) without revealing the monetary amount and/or the obfuscation amount of the masked electronic coin data set. These range proofs are also called “zero-knowledge range proofs”. It is preferred that ring signatures are used as range proof. Subsequently, a registering of the merging of the two masked electronic coin data subsets in the remote coin register occurs. The registering triggers, for example, the executing of the method described above for generating and encrypting a transaction data set, and the masked merged electronic coin data subset may be part of a transaction data set for the transaction register.

With the step of merging, two electronic coin data sets or two electronic coin data subsets can be cumulated. In this process, the monetary amounts and the obfuscation amounts are added together. Thus, as with splitting, a validity of the two original coin data sets can be performed during merging.

In a preferred embodiment, the registering step comprises receiving the masked coin data subset to be switched in the coin register, checking the masked coin data subset to be switched for validity; and registering the masked coin data set to be switched in the coin register if the checking step is successful, whereby the coin data subset to be switched is deemed to be checked.

A participating unit may have a security element present or may itself be a security element in which the electronic coin data set is securely stored. An application can be operationally integrated in the participating unit, which controls or at least initiates parts of the transferring method.

The transmission of electronic coin data sets can occur with the aid of terminals as participating units, which are logically and/or physically connected to the security elements.

Communication between two participating units, possibly with the respective security elements, can be wireless or wired, or e.g. also by optical means, preferably via QR code or barcode, and can be designed as a secure channel, for example between applications of the participating units. The optical path can comprise, for example, the steps of generating an optical code, in particular a 2D code, preferably a QR code, and reading in the optical code.

The transmitting of the electronic coin data set is secured, for example, by cryptographic keys, for example a session key negotiated for an electronic coin data set exchange or a symmetric or asymmetric key pair.

By the communicating between participating units, for example via their security elements, the exchanged electronic coin data sets are protected against theft or manipulation. The security element level thus complements the security of established Blockchain technology.

In a preferred embodiment, the transmitting of the coin data sets occurs as APDU commands. For this purpose, the coin data set is preferably stored in an (embedded) UICC as a security element and is managed there. An APDU is a combined command/data block of a connection protocol between the UICC and a terminal. The structure of the APDU is defined by the ISO-7816-4 standard. APDUs represent an information element of the application layer (layer 7 of the OSI layer model).

Furthermore, it is advantageous that the electronic coin data sets can be transmitted in any formatting. This implies that they can be communicated, thus transmitted, on any channels. They do not have to be stored in a fixed format or in a certain program.

A participating unit is in particular considered to be a mobile telecommunications terminal, for example a smartphone. Alternatively or additionally, the participating unit can also be a device, such as a wearable, smart card, machine, tool, vending machine or even container or vehicle. A participating unit is thus either stationary or mobile. The participating unit is preferably arranged to use the internet and/or other public or private networks. For this purpose, the participating unit uses a suitable connection technology, for example Bluetooth, LoRa, NFC and/or WiFi and has at least one corresponding interface. The participating unit can also be arranged to be connected to the internet and/or other networks by means of access to a cellular network.

For example, two participating units provide a local wireless communication connection via whose protocol the transmission between the two security elements located therein is then introduced.

In one embodiment, it can be provided that the first and/or second security element processes the received electronic coin data sets according to their monetary value when several electronic coin data sets are present or received. Thus, it can be provided that electronic coin data sets with a higher monetary value are processed before electronic coin data sets with a lower monetary value.

In one embodiment, the participating unit can be arranged, after receiving an electronic coin data set, to merge it depending on attached information, for example a currency or denomination, with an electronic coin data set already present in the participating unit and to correspondingly execute a step of merging. Furthermore, the participating unit can also be designed to automatically perform a switching after receiving the electronic coin data set.

In one embodiment, further information, in particular metadata, is transmitted from the first participating unit or first security element to the second participating unit or second security element upon transmitting, for example a currency. In one embodiment, this information may be comprised by the electronic coin data set.

The methods are not limited to a currency. For example, the payment system may be arranged to manage different currencies from different issuing entities. For example, the payment system is configured to convert (=change) an electronic coin data set of a first currency into an electronic coin data set of another currency. This changing is also a modification of the electronic coin data set. With the change, the original coin data set becomes invalid and is considered returned. Flexible payment with different currencies is thus possible and user-friendliness is increased.

The methods also allow the electronic coin data set to be converted into book money, for example, the monetary amount to be redeemed into an account of the participant in the payment system. This conversion is also a modification. Upon redemption, the electronic coin data set becomes invalid and is considered returned.

Preferably, the at least one initial electronic coin data set is created exclusively by the issuing entity, although preferably the split electronic coin data sets, in particular electronic coin data subsets, may also be generated by a participant unit. Preferably, creating and selecting a monetary amount also includes selecting a high entropy obfuscation amount. The issuing entity is a computing system, which is preferably remote from the first and/or second participating unit. After creating the new electronic coin data set, the new electronic coin data set is masked in the issuing entity by applying the homomorphic one-way function to the new electronic coin data set to accordingly obtain a masked new electronic coin data set. Further, additional information needed for registering the creating of the masked new electronic coin data set in the remote coin register is computed in the issuing entity. Preferably, this further information is a proof that the (masked) new electronic coin data set originates from the issuing entity, for example by signing the masked new electronic coin data set. In one embodiment, it may be provided that the issuing entity signs a masked electronic coin data set with its signature when generating the electronic coin data set. The signature of the issuing entity is stored in the coin register for this purpose. The signature of the issuing entity is different from the generated signature of a participating unit or a security element.

Preferably, the issuing entity can deactivate an electronic coin data set in its possession (thus of which it knows the monetary amount and the obfuscation amount) by masking the masked electronic coin data set to be deactivated with the homomorphic one-way function and preparing a deactivating command for the coin register. Part of the deactivating command is preferably, in addition to the masked electronic coin data set to be deactivated, proof that the deactivate step was initiated by the issuing entity, for example in the form of the signed masked electronic coin data set to be deactivated. As additional information, the deactivating command could contain range checks for the masked electronic coin data set to be deactivated. The deactivating may be the result of a return. This is followed by registering the deactivating of the masked electronic coin data set in the remote coin register. The deactivating command triggers the deactivating step. The creating and deactivating steps only occur in secured locations, in particular not in the participating units.

The steps of creating and deactivating are only performed or triggered by the issuing entity. Preferably, these steps occur in a secure location, for example in a hardware and software architecture designed to process sensitive data material in unsafe networks. Deactivating the corresponding masked electronic coin data set has the effect that the corresponding masked electronic coin data set is no longer available for further processing, in particular transactions. However, in one embodiment, it may be provided that the deactivated masked electronic coin data set remains archival with the issuing entity. The fact that the deactivated masked electronic coin data set is no longer valid or returned may be indicated, for example, by means of a flag or other coding, or the deactivated masked electronic coin data set may be destroyed and/or deleted. The deactivated electronic coin data set is also physically removed from the participating unit or security element.

The method according to the invention allows various processing operations (modifications) for the electronic coin data sets and the corresponding masked electronic coin data sets. Each of the processing operations (in particular creating, deactivating, splitting, merging, and switching) is registered in the coin register and appended to the list of previous processing operations for the respective masked electronic coin data set in an unchangeable form. Each of the processing operations triggers, for example, the method for generating and encrypting a transaction data set. The registration is thereby independent of the payment process between the participating units, both in terms of time and location (spatially). The processing operations “generating” and “deactivating” (=returning), which concern the existence of the monetary amount itself, thus mean the creation and destruction up to the destruction of money, require an additional authorisation, for example in the form of a signature, by the issuing entity in order to be registered (thus logged) in the coin register. The remaining processing operations (splitting, merging, switching), of which splitting and merging can also be delegated by a participating unit to a further participating unit, do not require authorisation by the issuing entity or by the command initiator (=payer, e.g. participating unit or security element).

Processing in the direct transaction layer concerns only the ownership and/or allocation of coin data sets to participating units of the respective electronic coin data sets. A registration of the respective processing in the coin register or the monitoring register is realised, for example, by corresponding list entries in a database, which comprises a number of markings to be performed by the coin register. A possible structure for a list entry comprises, for example, column(s) for a predecessor coin data set, column(s) for a successor coin data set, a signature column for the issuing entity, a signature column for the sending and/or receiving security element, a signature column for coin distribution operations and at least one marking column. A change (modification) is final when the required markings have been validated by the coin register or the monitoring register, i.e. changed from “0” status to “1” status, for example, after the corresponding check. If a check fails or takes too long, it is changed from “-” status to “0” status instead, for example. Other status values are conceivable and/or the status values mentioned here are interchangeable. The statuses regarding the modifications are independent of the status during the transmitting process (inactive/active). Preferably, the validity of the respective (masked) electronic coin data sets is cumulated from the status values of the markers, each in a column for each masked electronic coin data set involved in the registering processing.

In a further example embodiment, at least two, preferably three, or even all of the aforementioned markings can also be replaced by a single marking that is set when all checks have been successfully completed. Furthermore, the two columns for predecessor data sets and successor data sets can be cumulated into one each, in which all coin data sets are listed together. This would make it possible to manage more than two electronic coin data sets per field entry and thus, e.g., to split them into more than two coin data sets.

The checks for checking whether a processing is final are already described above and are in particular:
Are the masked electronic coin data sets of the predecessor column(s) valid?
Does monitoring result in the correct check value?
Are the range proofs for the masked electronic coin data sets successful?
Is the signature of the masked electronic coin data set a valid signature of the issuing entity?
Does the sending/receiving participating unit (pseudonym) exceed a limit for a maximum permissible monetary amount, in particular per time unit?
Is the coin data set inactive due to transmitting between participating units?

Preferably, it holds that a masked electronic coin data set is also invalid when one of the following checks applies, thus when:
(1) the masked electronic coin data set is not registered in the coin register;
(2) the last processing of the masked electronic coin data set indicates that there are predecessor coin data sets for it, but that last processing is not final; or
(3) the last processing of the masked electronic coin data set indicates that there are successor coin data sets for it and that last processing is final;
(4) the masked electronic coin data set is not the successor to a valid masked electronic data set unless it is signed by the issuing entity;
(5) the monetary amount of the masked electronic coin data set results in a limit value for a maximum permissible monetary amount, in particular per time unit, being exceeded and the requested deanonymisation is rejected by the corresponding participating unit;
(6) an active status for a security element is listed in the coin register, but another participating unit requests an action (switching, combining, splitting) under possession indication.

Preferably, the coin register and the issuing entity are arranged in in a common server entity or are present as a computer program product on a server and/or a computer.

An electronic coin data set can be present in a plurality of different appearances and thus be exchanged via different communication channels, hereinafter also referred to as interfaces. A very flexible exchange of electronic coin data sets is thus created.

The electronic coin data set can be represented in the form of a file, for example. In this case, a file consists of data that belong together in terms of content, which is stored on a data carrier, data storage or storage medium. Each file is initially a one-dimensional sequence of bits that are normally interpreted cumulated to byte blocks. An application program (application) or an operating system of the security element and/or the terminal interpret this bit or byte sequence as, for example, a text, an image, or a sound recording. The file format used for this can be different, for example it can be a plain text file representing the electronic coin data set. In particular, the monetary amount and the blind signature are mapped as a file.

For example, the electronic coin data set is a sequence of American Standard Code for Information Interchange, or ASCII, characters. In particular, the monetary amount and the blind signature are mapped as this sequence.

The electronic coin data set can also be converted in a participating unit from one representation form into another representation form. For example, the electronic coin data set can be received as a QR code in a participating unit and output as a file or character sequence by the participating unit.

These different representation forms of one and the same electronic coin data set enable a very flexible exchange between participating units or security elements or terminals of different technical equipment using different transmission media (air, paper, wired) and taking into consideration the technical design of a participating unit. The choice of the representation form of the electronic coin data sets is preferably made automatically, for example on the basis of recognised or negotiated transmission media and device components. In addition, a user of a participating unit can also select the representation form for exchanging (=transmitting) an electronic coin data set.

In a simple case, the data storage is an internal data storage of the participating unit. This is where the electronic coin data sets are stored. Easy access to electronic coin data sets is thus ensured.

The data storage is in particular an external data storage, also called online storage. Thus, the security element or the participating unit has only one means of accessing the externally and thus securely stored electronic coin data sets. In particular, in the case of loss or malfunction of the security element or participating unit, the electronic coin data sets are not lost. Since the ownership of the (non-masked) electronic coin data sets is equal to the ownership of the monetary amount, money can be maintained and managed more securely by using external data storage.

If the coin register is a remote entity, the participating unit and also the issuing entity preferably have an interface for communication by means of a common internet communication protocol, for example TCP, IP, UDP, or HTTP. The transmission may include communication over the cellular network.

In a preferred embodiment, the interface for outputting (=sending) the at least one electronic coin data set is a protocol interface for wirelessly sending the electronic coin data set to the other security element via a participating unit by means of a communication protocol for wireless communication. In particular, near-field communication, for example by means of Bluetooth protocol or NFC protocol or IR protocol, is provided; alternatively or additionally, WLAN connections or cellular connections are conceivable. The electronic coin data set will then be adapted according to the protocol properties or integrated into the protocol and transmitted.

In a preferred embodiment, the interface for outputting at least one electronic coin data set is a data interface for providing the electronic coin data set to the other participating unit by means of an application. In contrast to the protocol interface, the electronic coin data set is transmitted by an application. This application then transmits the electronic coin data set in a corresponding file format. A file format specific to electronic coin data sets can be used. In its simplest form, the coin data set is transmitted as an ASCII character sequence or as a text message, for example SMS, MMS, instant messenger message (such as Threema or WhatsApp). In an alternative form, the coin data set is transmitted as an APDU character sequence. A wallet application may also be provided. Here, the exchanging participating units preferably ensure that an exchange is possible by means of the application, thus that both participating units have the application and are ready to exchange.

In a preferred embodiment, the participating unit further has an interface for receiving electronic coin data sets.

In a preferred embodiment, the interface for receiving the at least one electronic coin data set is an electronic detection module of the security element or the terminal, configured for detecting an electronic coin data set represented in visual form. The detection module is then, for example, a camera or a barcode or QR code scanner.

In a preferred embodiment, the interface for receiving the at least one electronic coin data set is a protocol interface for wirelessly receiving the electronic coin data set from another security element or terminal by means of a communication protocol for wireless communication. In particular, near-field communication, for example by means of Bluetooth protocol or NFC protocol or IR protocol, is provided. Alternatively or additionally, WLAN connections or cellular connections are conceivable.

In a preferred embodiment, the interface for receiving the at least one electronic coin data set is a data interface for receiving the electronic coin data set from the other participating unit by means of an application. This application then receives the coin data set in a corresponding file format. A file format specific to coin data sets can be used. In its simplest form, the coin data set is transmitted as an ASCII character sequence or as a text message, for example SMS, MMS, Threema or WhatsApp. In an alternative form, the coin data set is transmitted as an APDU character sequence. In addition, the transmission may occur by means of a wallet application.

In a preferred embodiment, the participating unit comprises at least one security element reader arranged configured for reading a security element; a random number generator; and/or a communication interface to a vault module and/or bank entity with access to be authorised to a bank account.

In a preferred embodiment, the data storage is a shared data storage accessible by at least one other participating unit, each having an application, said application being configured for communicating with the coin register for registering electronic coin records accordingly.

What is proposed here is thus a solution that issues digital money in the form of electronic coin data sets inspired by the use of conventional (analogue) banknotes and/or coins. The digital money is represented here by electronic coin data sets. As with (analogue) banknotes, these electronic coin data sets can be used for all forms of payments, including peer-to-peer payments and/or POS payments. Knowledge of all the components (in particular monetary amount and obfuscation amount) of a valid electronic coin data set is equivalent to ownership (possession) of the digital money. It is therefore advisable to keep these valid electronic coin data sets confidential, e.g. to maintain them in a security element/vault module (of a terminal) and process them there. In order to decide on the authenticity of an electronic coin data set and to prevent double spending, masked electronic coin data sets are kept in the coin register as a unique corresponding public representation of the electronic coin data set. Knowledge or possession of a masked electronic coin data set does not constitute possession of money. Rather, it is akin to checking the authenticity of the analogue means of payment.

The coin register also contains, for example, flags about performed and planned processing of the masked electronic coin data set. From the markings on the processing, a status of the respective masked electronic coin data set is derived, indicating whether the corresponding (non-masked) electronic coin data set is valid, i.e. ready for payment. Therefore, a recipient of an electronic coin data set will first generate a masked electronic coin data set and have the coin register authenticate the validity of the masked electronic coin data set. A major advantage of this solution according to the invention is that the digital money is distributed to terminals, merchants, banks and other users of the system, but no digital money or further metadata is stored with the coin register or the monitoring register—thus shared entities.

The proposed solution can be integrated into existing payment systems and infrastructures. In particular, there can be a combination of analogue payment transactions with banknotes and coins and digital payment transactions according to the present solution. Thus, a payment transaction can be made with banknotes and/or coins, but the change or change back is present as an electronic coin data set. For example, ATMs with a corresponding configuration, in particular with a suitable communication interface, and/or mobile terminals can be provided for the transaction. Furthermore, a change of electronic coin data set into banknotes or coins is conceivable.

The steps of creating, switching, splitting, merging and deactivating (returning) are each triggered by a corresponding creating, switching, splitting, merging or deactivating command (return commands).

### BRIEF SUMMARY OF FIGURES

In the following, the invention or further embodiments and advantages of the invention will be explained in more detail with reference to figures, wherein the figures only describe example embodiments of the invention. Same components in the figures are given the same reference signs. The figures are not to be regarded as true to scale, and individual elements of the figures may be shown in exaggeratedly large or exaggeratedly simplified form.

It is shown:

FIG. 1 an example embodiment of a payment system with an issuing entity according to the invention;

FIG. 2 a further development of the example embodiment of a payment system of FIG. 1;

FIG. 3 a further development of the example embodiment of a payment system of FIG. 1;

FIG. 4 a further development of the example embodiment of a payment system of FIG. 1;

FIG. 5 an example embodiment of a issuing entity according to the invention;

FIG. 6 an example embodiment of a method flow diagram of a method according to the invention in an issuing entity;

FIG. 7 an example embodiment of a data structure in the coin register;

FIG. 8 an example embodiment of a system according to the invention for splitting and switching and directly transmitting electronic coin data sets;

FIG. 9 an example embodiment of a payment system according to the invention for merging electronic coin data sets;

FIG. 10 two example embodiments of a method flow diagram of a method according to the invention and corresponding processing steps of a coin data set;

FIG. 11 an example embodiment of a method flow diagram of a method according to the invention and corresponding processing steps of a coin data set;

FIG. 12 an example embodiment of a method flow diagram of a method according to the invention and corresponding processing steps of a coin data set;

FIG. 13 an example embodiment of a method flow diagram of a method according to the invention and corresponding processing steps of a coin data set;

### FIGURE DESCRIPTION

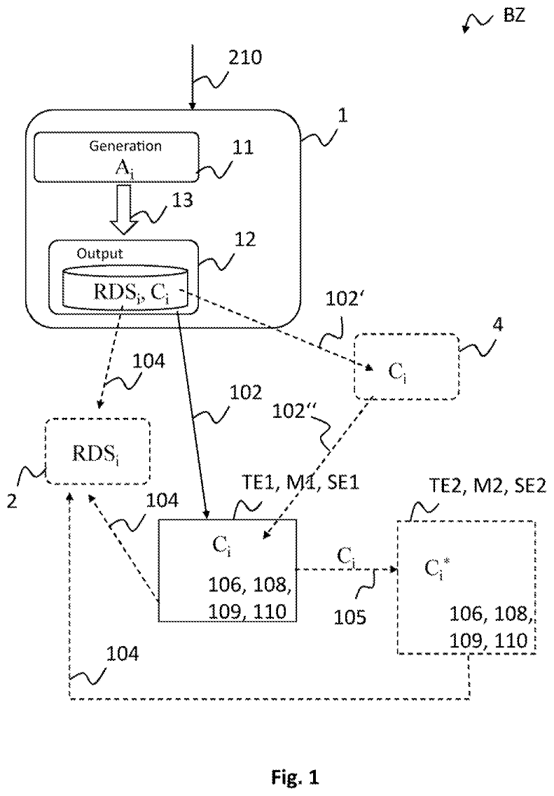

FIG. 1 shows an example embodiment of a payment system BZ according to the invention. The dashed blocks and arrows of the payment system BZ are optional here. The payment system BZ comprises at least two security elements SE1 and SE2. The SE1 and SE2 can be operationally integrated in the respective terminals M1 and M2 and logically or physically connected to the respective terminal M1 and M2.

Furthermore, the payment system in FIG. 1 contains a issuing entity 1 which generates the electronic coin data set C. A register data set, RDS, e.g. a masked electronic coin data set Z, is generated for the electronic coin data set C and is registered 104 in the coin register 2 of the payment system. The electronic coin data set C is output by the issuing entity 1 to the first terminal M1 in step 102. The register data set RDS, for example the masked electronic coin data set Z, is output to the coin register 2 in step 104, for example by the issuing entity 1 directly or via the first terminal M1. The register data set RDS, for example the masked electronic coin data set Z, is alternatively generated by the first terminal M1 (or the second terminal M2) and sent to the coin register 2 in step 104.

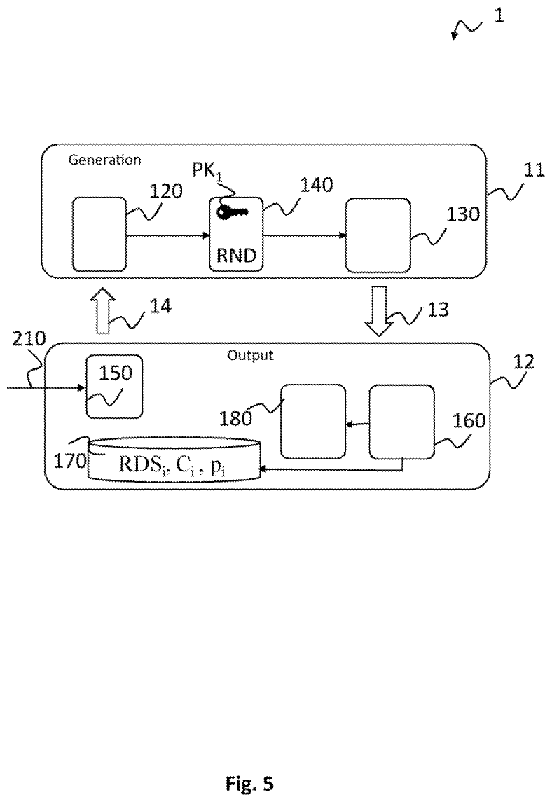

To generate an electronic coin data set, eMDS, C the following method is proposed. A request 210 from a central bank or a participating unit TE or a commercial bank for generating an electronic coin data set is obtained by the issuing entity 1. The issuing entity 1 has a coin generating unit 11 and a coin output unit 12. Both units 11, 12 are separated from each other and have an air gap 13. The air gap 13 serves to ensure that the highly sensitive security-relevant data of the payment system BZ present in the issuing entity 1, in particular one or more private keys PK and a random number generator, cannot be read out via a network attack on the issuing entity 1 and used for manipulations of the payment system BZ. In this regard, the coin generating unit 11 should be completely isolated. For example, the coin generating unit 11 is designed without an interface to a network, such as TCP/IP, the Internet, the mobile network, etc., and without an interface to other terminals, such as NFC or Bluetooth. The air gap process 13 is explained in detail in FIG. 5.

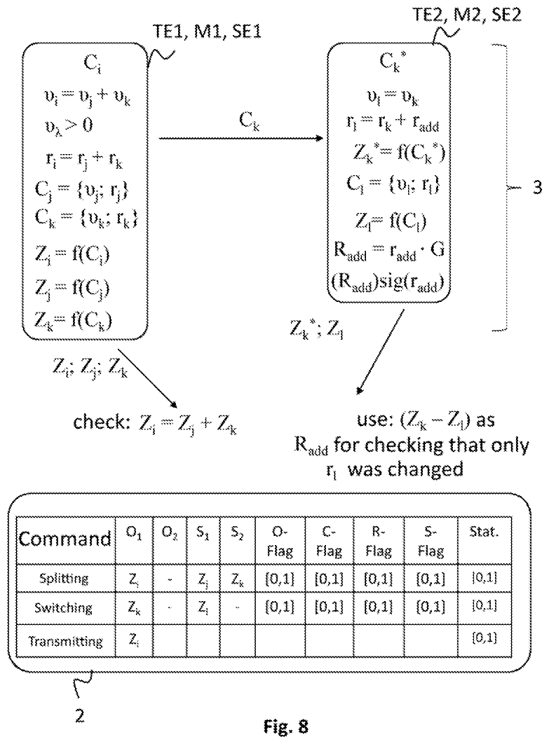

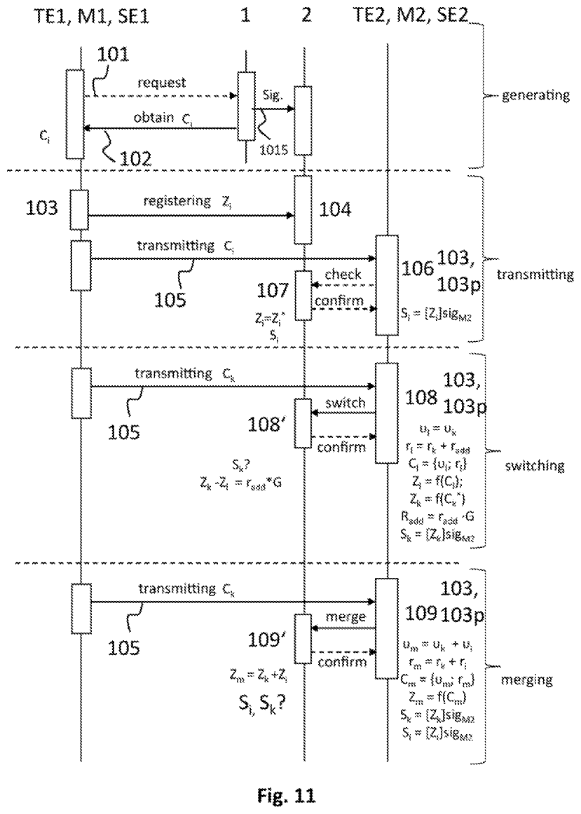

The electronic coin data set C to be generated is requested at the issuing entity 1 in step 210. The request 210 may have been generated by a central bank. As an alternative, the participating unit TE requests the electronic coin data set C. Steps 104 and 105 may correspond to steps 104 and 105 of FIG. 11. An action (splitting, merging, switching, transmitting, redeeming, exchanging) on the eMD C may correspond to any of the actions of FIGS. 8 to 12.

In the coin generating unit 1, for example, a true random number is generated as the obfuscation amount rᵢ by means of a random number generator. The obfuscation amount rᵢ is known in the direct transaction layer 3 and also in the issuing entity 1, but it is secret for the remaining entities of the payment system BZ, thus also for the coin register 2. The obfuscation amount rᵢ is being linked to a monetary amount vᵢ. Accordingly, an i-th electronic coin data set generated by the coin generating unit 1 according to the invention could read:

Cᵢ={vᵢ;rᵢ} (1)

In addition to these data elements, the electronic coin data set C can comprise at least one check value p. For example, the check value p represents the return condition mentioned above.

In addition to these data elements, the electronic coin data set C may comprise a coin identifier. For example, the coin identifier is a unambiguous number that only exists once in the payment system BZ. For example, the coin identifier M-ID is a random number generated by the issuing entity 1 or a serial number. A valid electronic coin data set C can be employed for payment. The owner of the two values vᵢ and rᵢ is therefore in possession of the digital money. The digital money is defined by a pair consisting of a valid electronic coin data set Cᵢ and a corresponding register data set RDSᵢ, for example a masked electronic coin data set Zᵢ. For example, a masked electronic coin data set Zᵢ as RDS, is obtained by applying a homomorphic one-way function f (Cᵢ) according to equation (2):

Zᵢ=f(Cᵢ) (2)

This function f (Cᵢ) is public, i.e. every system participant can call and use this function. This function f (Cᵢ) is defined according to equation (3):

Zᵢ=vᵢ·H+rᵢ·G (3)

wherein H and G are generator points of a group G in which the discrete logarithm problem is difficult, with the generators G and H for which the discrete logarithm of the other basis is unknown. For example, G and H are generator points of an elliptic curve cipher, ECC, —thus, private keys of the ECC. These generator points G and H must be chosen in such a way that the relation of G and H is not publicly known, so that at:

G=n·H (4)

the linking n must be practically undetectable to prevent the monetary amount vᵢ from being manipulated and yet a valid Zᵢ could be calculated. Equation (3) is a “Pederson commitment for ECC”, which ensures that the monetary amount vᵢ can be conceded, i.e. “committed”, to a coin register 2 without revealing it to the coin register 2.

Alternatively, the RDS may comprise an amount category in addition to the masked coin data set Zᵢ. The amount category is a pseudonymized form of the monetary amount vᵢ of the electronic coin data set C. For example, the amount category is a range (from to) in which the monetary amount vᵢ lies. For example, the amount category is a range threshold value (greater than; smaller than) above or below which the monetary amount vᵢ lies. For example, the amount category is a rounded-down value of the monetary amount vᵢ. For example, the amount category is a rounded-up value of the monetary amount vᵢ. This makes the RDS amount-pseudonymous and identity-anonymous.

Alternatively, the RDS may comprise a coin identifier M-ID in addition to or instead of the masked coin data set Zᵢ. Thus, in the RDS, a unambiguous reference to the electronic coin data set C is created.

Alternatively, the RDS may comprise a pseudonym P of the participating unit. The pseudonym can be managed in the pseudonym association 7. This makes the RDS amount anonymous and identity-pseudonymous. In this embodiment, the RDS may comprise a check value p of the coin data set as well.

In the following, for simplicity, an RDS may be equated with a masked coin data set Z, as this is a very preferred embodiment.

The RDS, for example the masked coin data set Zᵢ, is sent (revealed) to the coin register 2, which is depicted in FIG. 1 as step 104 (registering, registration request).

The RDS can here be provided by the issuing entity 1 for the coin register 2. The RDS is preferably generated in the coin generating unit 11, but can also be generated in the coin output unit 12.

Even though in the present example an encryption based on elliptic curves is described, another cryptographic method based on a discrete logarithmic method would also be conceivable.

Equation (3) allows, through the entropy of the obfuscation amount rᵢ, to obtain a cryptographically strong Zᵢ even with a smaller range of values for monetary amounts vᵢ. Thus, a simple brute force attack by merely estimating monetary amounts vᵢ is practically impossible.

Equation (3) is a one-way function, which means that calculating Zᵢ from Cᵢ is easy because an efficient algorithm exists, whereas calculating Cᵢ starting from Zᵢ is very difficult because no algorithm exists that can be solved in polynomial time.

Moreover, equation (3) is homomorphic for addition and subtraction, which means:

Zᵢ+Zⱼ=(vᵢ·H+rᵢ·G)+(vⱼ·H+rⱼ·G)=(vᵢ+vⱼ)·H+(rᵢ+rⱼ)·G (5)

Thus, addition operations and subtraction operations can be performed both in the direct transaction layer 3 and in parallel in the coin register 2 without the coin register 2 having knowledge of the electronic coin data sets Cᵢ. The homomorphic property of equation (3) allows monitoring of valid and invalid electronic coin data sets Cᵢ on the basis of the electronic coin data set Zᵢ alone and ensuring that no new monetary amount vⱼ has been created. This homomorphic property allows the coin data set Cᵢ to be split into, according to equation (1):

Cᵢ=Cⱼ+Cₖ={vⱼ;rⱼ}+{vₖ;rₖ} (6)

wherein:

vᵢ=vⱼ+vₖ (7)

rᵢ=rⱼ+rₖ (8)

For the corresponding masked coin data sets holds:

Zₗ=Zⱼ|Zₖ (9)

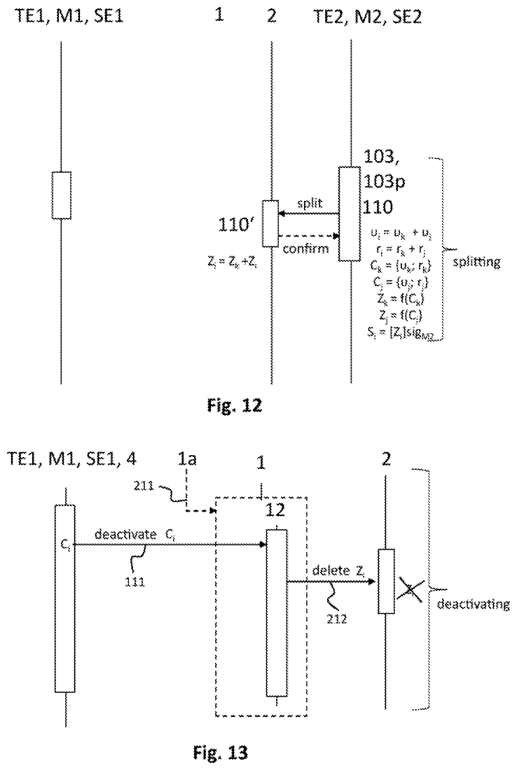

For example, equation (9) can be used to easily check a “symmetrically or asymmetrically splitting” processing or a “symmetrically or asymmetrically splitting” processing step 110 of a coin data set according to FIG. 8 or 12 without the coin register 2 having knowledge of Cᵢ, Cⱼ, Cₖ. In particular, the condition of equation (9) is checked to declare split coin data sets Cⱼ and Cₖ as valid and declare coin data set Cᵢ as invalid. Such a splitting 110 of an electronic coin data set Cᵢ is shown in FIG. 8 or 12.

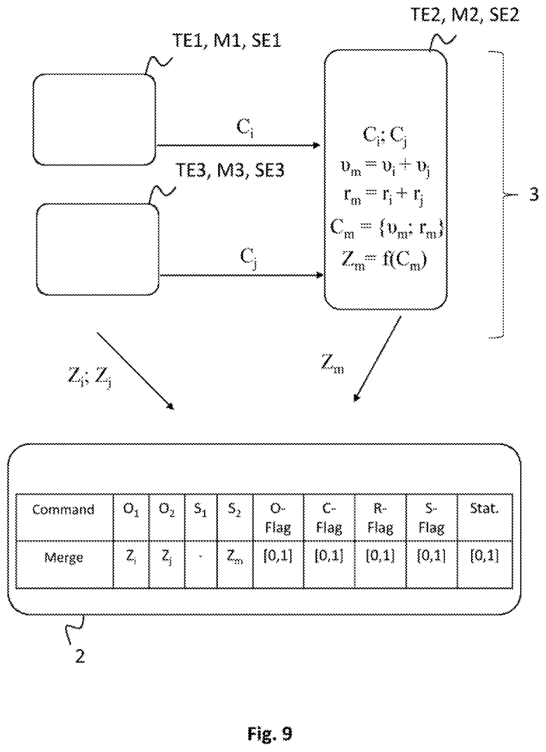

In the same way, electronic coin data sets C can also be joined (merged) 109 together, see FIG. 9 or 11 and the explanations thereto.

In addition, it is necessary to check whether (not allowed) negative monetary amounts are registered. An owner of an electronic coin data set Cᵢ must be able to prove to the coin register 2 and/or a monitoring register 6 that all monetary amounts vᵢ in a processing operation lie within a value range of [0, . . . , n] without informing the coin register 2 of the monetary amounts vᵢ. These range proofs are also called “range-proofs”. Preferably, ring signatures are used as range proofs. For the present example, both the monetary amount v and the obfuscation amount r of an electronic coin data set C are resolved in bit representation. It holds:

vᵢ=Σaⱼ·2^{j} for 0≤j≤n and aⱼ∈{0; 1} (9a)

as well as

rᵢ=Σbⱼ·2^{j} for 0≤j≤n and bⱼ∈{0; 1} (9b)

For each bit, a ring signature is preferably performed with

Cᵢⱼ=aⱼ·H+bⱼ·G (9c)

and

Cᵢⱼ−aⱼ·H (9d)

wherein in one embodiment it can be provided to perform a ring signature only for certain bits.

The embodiment of the payment system BZ shown in FIG. 1 shows in particular the generation of an electronic coin data set C for direct issuing to a participating unit TE1 (step 102). Alternatively, the issuing to the participating unit TE1 occurs indirectly via a bank entity 4 by the steps 102′ (providing the eMDS C to the bank 4) and in the subsequent step 102″ (providing the eMDS C to the TE1).

Generating the RDS by the issuing entity 1 is initially only optional here and can also be performed by the participating units TE1, TE2.

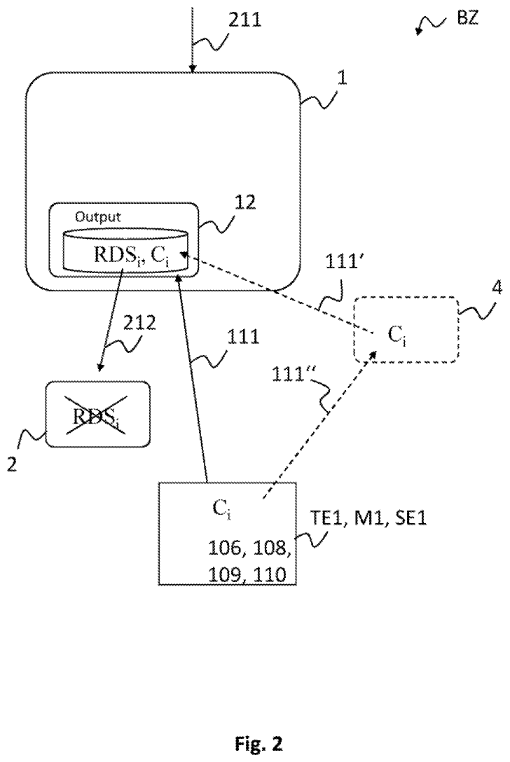

FIG. 2 shows a further development of the payment system BZ shown in FIG. 1. The explanations in FIG. 1 are referred to here in order to avoid repetitions. FIG. 2 describes the deactivating of a coin data set C. A participating unit TE1 decides to deactivate and return the coin data set C and sends a deactivating request in step 111. This step 111 may be the manifestation of a participant request, namely to credit a monetary amount of a coin data set to a participant's account, or may be based on the evaluation of a check value pᵢ, which has determined that the coin data set meets the criteria for return, for example, expiration of a validity period, reaching a return time, reaching an “age” (number of transmissions and modifications), or reaching a threshold value when the coin data set C is not used. Step 111 is displayed directly to the coin output unit 12. The notificating may also be indirect via the bank entity 4 (similar to obtaining the coin data set), which is depicted in FIG. 2 by steps 111′ and 111″. Following step 111, the crediting of the monetary amount to an account of the participant or by outputting cash at a dispensing tray of the unit 12 is initiated in the subsequent step (not depicted). In the depicted subsequent step 212, a disabling command is sent to the coin register 2 to clear the register data set RDS from the coin register 2 or to invalidate it therein. As a result, the RDS of the deactivated (credited) coin data set is deleted from coin register 2 (crossed-out RDS).

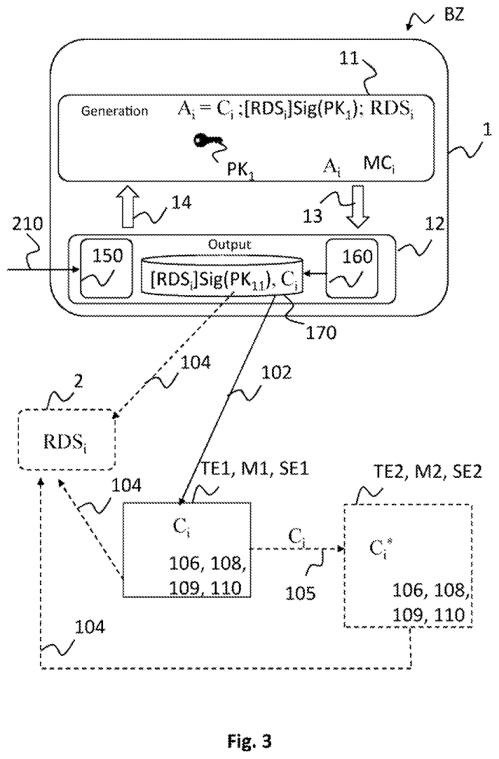

FIG. 3 shows a further development of the payment system BZ shown in FIG. 1. The explanations in FIG. 1 are referred to here in order to avoid repetitions. The coin output unit 12 of the issuing entity 1 of FIG. 3 has a receiving unit 150 at which coin generating requests arrive from a participating unit TE or a central bank (not depicted). The receiving unit 150 transmits this request 210 to the coin generating unit 11 by means of an air gap process 14. Thereby, the same mechanisms regarding the air gap process 13 as mentioned above and discussed in more detail in FIG. 5 may be applied and the same interfaces may be used. The coin generating unit 11 generates the coin data set C and also the register data set RDS.

To mark the register data set RDS as trustworthy, the coin generating unit 11 signs the generated register data set RDS with a private key PK of the issuing entity 1. The combination of electronic coin data set C, register data set RDS and signed register data set [RDS]Sig(PK) is represented by a printout Aᵢ, for example as a QR code. This printout A1 is provided to the coin output unit 12 via the air gap process 13. There, the printout A1 is read by means of a reading unit 160, for example a QR code scanner, to obtain the electronic coin data set C. Furthermore, the coin generating unit 11 creates metadata MC which are appended to the printout A1 or provided as a stand-alone transmission to the coin output unit 13.

The unit 160 checks the uniqueness of the coin data set Cᵢ by, for example, matching the metadata MCᵢ with metadata of the coin data sets C existing in the payment system BZ. For example, a serial number or a coin identifier is employed for this check. If the uniqueness of the coin data set Cᵢ is confirmed, it is stored in the coin storage 170 of the issuing entity 1 and output (uncorrelated in time) to a participating unit TE in step 102. Providing the RDS to the coin register 2 can already occur after checking for uniqueness or can only occur when a coin data set Cᵢ is requested by a TE or the bank entity 4.

Providing the RDS to the coin register 2 in step 102 enables registering the coin data set Cᵢ in the payment system BZ. In one embodiment, the RDS and the signed [RDS]Sig(PK) are provided for this purpose. By means of the public key of the issuing entity 1, the signature of the signed [RDS]Sig(PK) may be checked in the coin register 2 and if the check is successful, the RDS is registered as valid in the coin register 2. In another embodiment, the coin register 2 only receives the signed register data set [RDS]Sig(PK). As soon as a participating unit TE provides the register data set RDS directly to the coin register 2 (thus only after the coin data set C has been issued to the TE1 in step 102), the signature can be checked in the coin register 2 with the public key of the issuing entity 1 and, if the check is successful, the RDS is registered as valid in the coin register 2.

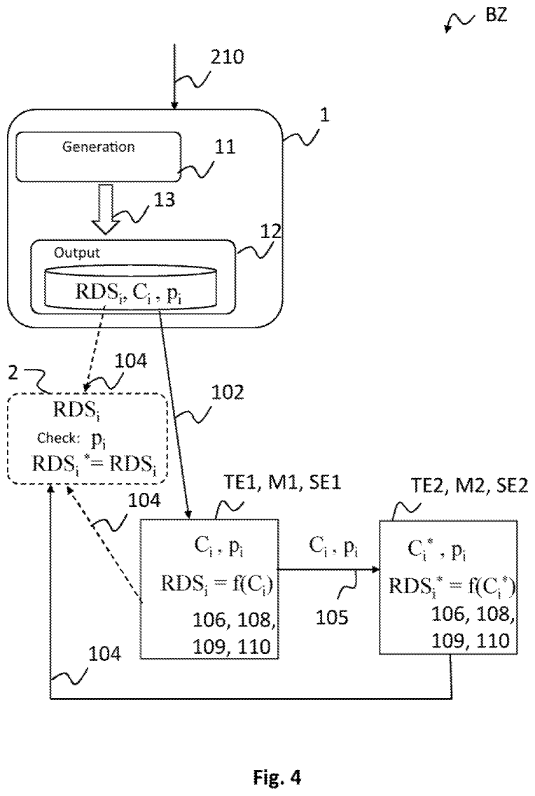

According to FIG. 4—a further development of the payment system BZ of FIG. 1 or 3, at least one check value p, (also called counter value) can additionally be kept in the electronic coin data set C as a further data element. In the payment system BZ, this counter value pi can be kept to determine whether the coin data set C is to be returned. Each action with coin data set C increases this counter value pi. Different action types weight the counter value pi differently, so that, for example, a direct transfer of the coin data set C has a higher weight than a modification (splitting, combining, switching). In this way, the lifetime and the actions maintained in it of a coin data set C are evaluated and criteria for its return are defined according to the actions maintained. The check value pi1 and also the counter value pᵢ map the life cycle of the coin data set C on the basis of which a decision is then made about its return.

In FIG. 4, an RDSᵢ, for example a masked electronic coin data set Zᵢ, for example in SE1, is calculated from the electronic coin data set Cᵢ by equation (3) and this RDSᵢ is registered in the coin register 2 together with the check value pᵢ.

In FIG. 5, an example embodiment of a issuing entity 1 of FIGS. 1 to 4 is depicted. The explanations in these figures are omitted to avoid repetition. The receiving unit 150 of the coin output unit 12 provides the request 210 of the coin generating unit 11 via the air gap process 14. An opto-electronic interface may be used for this purpose. The reading unit 120 of the coin generating unit 11 causes the coin generator 140 to generate the electronic coin data set and, optionally, the RDS and the signed RDS. The output unit 130 of the coin generating unit 11 creates a printout representing the coin data set C.

The coin generating unit 11 preferably does not have a network interface or direct data transmission connection to another terminal or an exchange (router, switch, hub) to ensure that the random number generator RND comprised in the coin generator 140 and the private key PKₗ of the issuing entity 1 used for signing cannot be compromised by network attack.

The printout Aᵢ has, for example, an alphanumeric character string. The printout alternatively or additionally has at least one opto-electronically readable code, for example a two-dimensional code such as a QR code or a one-dimensional code such as a barcode. The printout alternatively or additionally has at least one laser engraving, watermark and/or embossing. These techniques used in the value documents production increase the security of the air-gap-based transmission of the electronic coin data sets.

For example, the printout A is printed on a paper substrate, preferably on a security element-free substrate, for example white plain paper, in banknote format. Thus, the coin generating unit 11 can be part of a classic cash production machine, for example a banknote production machine. Alternatively, the printout A occurs on paper in DIN A4 format. Then a conventional printer can be used in the coin generating unit 11.

For example, multiple different electronic coin data sets are arranged on a printout, for example on an A4 page. Thus, in a practical way, multiple coin data sets C can be transmitted simultaneously via the air gap process 13 so that the transmission is much more efficient.

The coin output unit 11 here is a banknote processing machine. This allows the use of readers provided with banknote processing machines, such as scanners, 160 for reading the printouts A. A data check in the unit 160 recognizes duplicate coin data sets C in the payment system BZ and immediately carries out a destruction of the printout (shredding or sorting-out). A destruction unit 180 is provided in the coin output unit 12 for this purpose.

This printout destruction unit 180 for destroying invalid printouts A may destroy invalid printouts A, such as for example unreadable printouts or detected duplicate electronic coin data sets (represented by the printouts). Thus, no unchecked electronic coin data set C leaves the coin output unit 12. A check may be performed, for example, on the basis of metadata MC or register data of a database of the payment system BZ to which the coin output unit 12 has access. For example, serial numbers, a coin identifier, or similar data elements may be checked for double presence in the payment system BZ. A destruction unit 150 is, for example, a mechanical fragmentation device (shredder) that physically fragments the printouts and destroys them as a result. Alternatively, the destruction unit 150 is a sorting-out compartment in which the invalid printouts are deposited. Such destruction units 150 could be destruction units of banknote processing machines.

According to FIGS. 1, 3 and 4, the transmitted electronic coin data set Cᵢ is obtained as Cᵢ* in TE2. With obtaining the electronic coin data set Cᵢ*, the TE2 is in possession of the digital money represented by the electronic coin data set Cᵢ*. With the direct transmission 105, it is available to the TE2 for further actions.

Due to the higher trustworthiness when using SEs, SE1, SE2 can trust each other and in principle no further steps are necessary for transmitting 105. However, SE2 does not know whether the electronic coin data set Cᵢ* is actually valid. To further secure the transmitting 105, further steps can be provided in the method, as explained below

For checking the validity of the obtained electronic coin data set Cᵢ*, a further RDS, for example the masked transmitted electronic coin data set Zᵢ*, can be calculated in SE2 using the—public—one-way function from equation (3). The RDS, thus for example the masked transmitted electronic coin data set Zᵢ*, is then transmitted to the coin register 2 in step 104 and searched for there. If both RDSs match with respect to the same coin data set C, for example a match with a registered and valid masked electronic coin data set Zᵢ, the validity of the obtained coin data set Cᵢ* is displayed to the SE2 and it holds that the obtained electronic coin data set Cᵢ* is equal to the registered electronic coin data set Cᵢ. In one embodiment, the validity check can be used to determine that the obtained electronic coin data set Cᵢ* is still valid, i.e. that it has not already been used by another processing step or in another transaction/action and/or has not been subject to a further modification.

Preferably, a switching of the received electronic coin data set occurs afterwards.

The sole knowledge of an RDS, thus for example of a masked electronic coin data set Zᵢ, does not authorise to spend the digital money of the corresponding electronic coin data set Cᵢ.

The sole knowledge of the electronic coin data set Cᵢ entitles to pay, i.e. to perform a transaction successfully, in particular when the coin data set Cᵢ is valid, for example when the electronic coin data set Cᵢ has an active status. The status is preferably set to an active status only upon obtaining the acknowledgement of deletion from the SE1. There is a bijective relationship between the electronic coin data sets Cᵢ and the corresponding masked electronic coin data sets Zᵢ. The masked electronic coin data sets Zᵢ are registered in the coin register 2, for example a public database. This registering 104 first makes it possible to check the validity of the electronic coin data set Cᵢ, for example whether new monetary amounts have been created (illegally).

The masked electronic coin data sets Zᵢ are stored in the coin register 2. All processing on the electronic coin data set Zᵢ is registered there, whereas the actual transmission of the digital money occurs in a (secret, i.e. not known to the public) direct transaction layer 3 of the payment system BZ. Furthermore, in this payment system BZ, monitoring the coin data set C and the participating unit TE can be accommodated in a monitoring register 6.

In order to prevent multiple spending or to ensure more flexible transmitting 105, the electronic coin data sets C can be modified. The following table 1 lists exemplary operations, whereby a corresponding processing step is also executed with the specified command:

TABLE 1
Number of operations that can be performed per processing
of a C in the TE or the issuing entity

| Command | Create | Create random | Create | Create range |
|---|---|---|---|---|
| or step | signature | number | masking | proof |
| Generating | 1 | 1 | 1 | 0 or 1 |
| Returning | 1 | 0 | 1 | 0 or 1 |
| Splitting | 1 | 1 | 3 | 0 or 1 |
| Merging | 1 | 0 | 3 | 1 |
| Splitting | 1 | 1 | 2 | 1 |

Further operations not listed in table 1 may be required, for example changing the currency or redeeming the monetary amount on an account. Instead of the listed implementation, other implementations are also conceivable that imply other operations. Table 1 shows that for each coin data set, each of the processings (modifications) “generating”, “returning”, “splitting”, “merging” and “switching” can provide different operations “create signature”; “create random number”; “create masking”; “range check”, each of the processing operations being registered in the coin register 2 and appended there in an invariable form to a list of previous processing operations for masked electronic coin data sets Zᵢ. The operations of the processings “generating” and “returning” an electronic coin data set C are executed only in secure locations and/or only by selected entities, for example the issuing entity 1, while the operations of all other processing operations can be executed on the participating units TE, i.e. the terminals M or their security elements SE.

The number of operations for each processing is marked “0”, “1”, or “2” in table 1. The number “0” here indicates that the participating unit TE or the issuing entity 1 does not need to perform this operation for this processing of the electronic coin data set C. The number “1” here indicates that the participating unit TE or the issuing entity 1 must be able to perform this operation once for this processing of the electronic coin data set C. The number “2” here indicates that the TE or the issuing entity 1 must be able to perform this operation twice for this processing of the electronic coin data set.

In addition, in one embodiment, it can also be provided that a range check is performed by the issuing entity 1 during generating and/or deleting.

Table 2 below lists the operations required for the coin register 2 and/or the monitoring register 6 for the individual processings:

TABLE 2
Number of operations that can be performed per processing of a C in the coin register

| | | | | | Retrace homomorphic |
|---|---|---|---|---|---|
| | | Check | Check validity | | properties of the |
| | Check | signature | of masked | | masked electronic |
| Command | signature | of security | electronic | Retrace | coin data sets, i.e. |
| or step | of issuer | element | coin data set | range proof | adding or subtracting |
| Generating | 1 | 0 | 0 | 0 or 1 | 0 |
| Returning | 1 | 0 | 1 | 0 or 1 | 0 |
| Splitting | 0 | 1 | 1 | 2 or more | 1 |
| Merging | 0 | 1 | 2 or more | 1 | 1 |
| Switching | 0 | 1 | 1 | 1 | 0 |

Further operations not listed in Table 2 may be required. Instead of the listed implementation, other implementations are conceivable that imply other operations. All operations of table 2 can be performed in the coin register 2, which as a trusted entity, for example as a server entity, for example as a distributed trusted server, ensures sufficient integrity of the electronic coin data sets C.

Table 3 shows the preferred components to be installed for the system participants in the payment system of FIG. 1:

TABLE 3
Preferred units in the system components

| | Issuing | Participating | Coin |
|---|---|---|---|
| Command or step | entity | unit | register |
| Random number generator | Yes | — | — |
| (high security) | | | |
| Randomised generator | — | Yes | —/—/Yes |
| (deterministic) | | | |
| PKI for signing | Yes | Yes | —/—/Yes |
| PKI for signature check | — | (Yes) | Yes |
| Read access | Yes | Yes | Yes |
| Write access | Yes | Yes | Yes |
| Returning the electronic | Yes | Yes | — |
| coin data set | | | |
| Transport encryption | Yes | Yes | —/—/Yes |
| Secure storage | (Yes) | Yes | —/—/Yes |
| Masking unit | Yes | Yes | — |
| Range proof | — | Yes | — |
| Check range proof | — | — | Yes/Yes/— |

Table 3 shows an overview of the preferred components to be used in each system participant, thus the issuing entity 1, a participant unit TE, and the coin register 2.

The participating units TE can be arranged by means of an e-wallet for electronic coin data sets Cᵢ (with the check value p, pᵢ₁ pᵢ₂), i.e. as an electronic purse with a memory area in which a plurality of coin data sets Cᵢ can be stored, and thus implemented, for example, in the form of an application on a smartphone or IT system of a trader, a commercial bank, or another market participant. Thus, the components in the participating unit TE, as shown in Table 3, are implemented as software. It is assumed that the coin register 2, the transaction register 4, and/or the monitoring register 6 are based on a server or on a DLT and are operated by a number of trusted market participants.

In the coin register 2, an RDS regarding the electronic coin data set C can be replaced by an RDS to be registered regarding the electronic coin data set C or of a modified electronic coin data set C. Thus, (only) current coin data sets C—existing in the payment system BZ—are maintained as RDS in coin register 2.

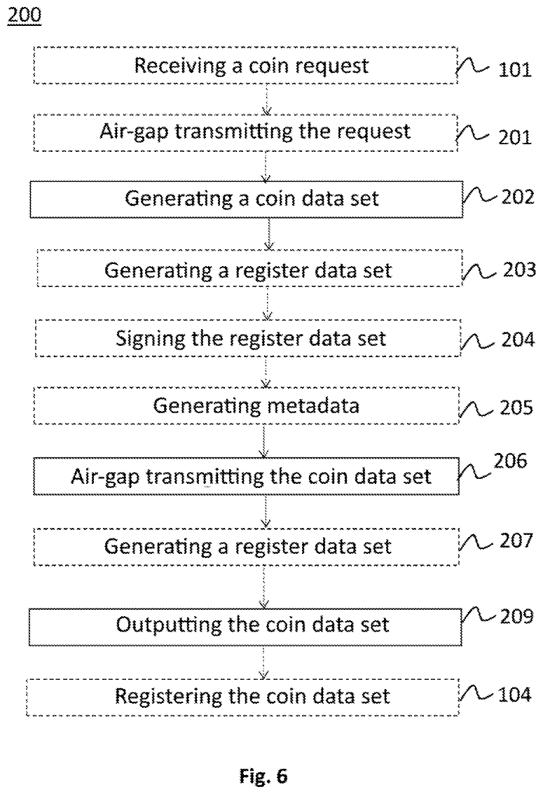

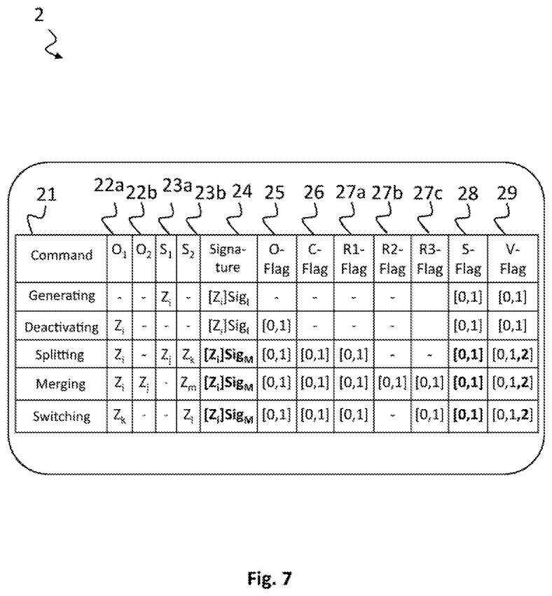

FIG. 6 shows a method flow diagram of a method 200 for generating and issuing an electronic coin data set C in an issuing entity 1. In the optional step 101, a coin request is received in the issuing entity 1, for example the receiving unit 150. The request 101 may have been made by a central bank or also by a participating unit TE or a commercial bank 4 of the payment system BZ. In optional step 201, this request is sent to the coin generating unit 11 of the issuing entity 1 by means of an air gap process 14. In step 202, an electronic coin data set is generated (for example, in the coin generator 140). In addition, an RDS and a signed RDS may be generated in optional steps 203 and 204. In optional step 205, metadata is generated. In step 206, the electronic coin data set C is sent to the coin output unit of the issuing entity 1 by means of an air gap process 13, optionally with the RDS and the signed RDS. Preferably, a printout A is generated for this purpose. The printout A is transported to the coin output unit 12. Alternatively, a secured transport box (container with optical, mechanical or digital seal or mechanical or digital lock) is used to transmit the printout (or printouts). The printout is brought to a reading region of the coin output unit 12 to be read. Preferably, a banknote production infrastructure is used. In the optional step 207, the RDS may be generated, should it not have already been generated and transmitted along in step 203. Not shown is an intermediate storing of the coin data set C in the coin storage 170 of the issuing entity 1. In step 209, the generated electronic coin data set C is output to a requesting (step 101) participating unit TE or a bank entity 4. In optional step 104, the coin data set C is registered in the coin register 2, for example by transmission of the RDS and/or the signed RDS. FIG. 7 shows a data structure for a coin register 2 of the preceding figures.

FIG. 7 depicts data of the coin register 2 for illustrative purposes, here the masked electronic coin data sets Zᵢ and their processing, if any, are registered. The coin register 2 may be accommodated in a server entity. The register 2 is preferably arranged locally remote from the participating units TE and accommodated for example in a server architecture.

Each processing operation for a processing (creating, deactivating, splitting, merging, and switching) here is registered in the coin register 2 and appended to a list of previous processing operations for masked electronic coin data sets Zᵢ, for example, in an unchangeable form. The individual operations or their check results, thus the intermediate results of a processing, are kept in the coin register 2. Although a continuous list is assumed in the following, this data structure can also be cleaned or compressed, if necessary according to predetermined rules, or provided separately in a cleaned or compressed form.

The processings “generating” and “deactivating”, which regard the existence of the monetary amount vᵢ per se, i.e. the creation and destruction of money, require additional authorisation by the issuing entity 1 in order to be registered (thus logged) in the coin register 2. The other processing operations (splitting, merging, switching) do not require authorisation by the issuing entity 1 or by the command initiator (=payer, e.g. the first terminal M1). However, the other processing operations are to be checked with regard to various check criteria.

A registration of the respective processing is realised, for example, by corresponding list entries in the database according to FIG. 7. These list entries are the RDS. Each list entry has further markings 25 to 28 which document the intermediate results of the respective processing which must be performed by the coin register 2. Preferably, the markings 25 to 28 are used as an aid and are discarded by the coin register 2 after the commands have been completed.

A coin data set can be treated as valid when the necessary checks have occurred. For example, an optional marking 29 can indicate the completion of the processing. Markings 29 are in the “-” state when a processing command is received, for example, and are set to the “1” state after all checks have been successfully completed (to markings 25-28) and are set to the “0” state if at least one check has failed. A (completion) marking 29 with the value “2” could, for example, indicate that only the necessary checks were completed and that checks that could be made up for were omitted.

A possible structure for a list entry of a coin data set comprises, for example, two columns 22a, 22b for a predecessor coin data set (O1, O2), two columns 23a, 23b for a successor coin data set (S1, S2), a signature column 24 for signatures of issuing entity/entities 1 and signatures of terminals M, and six marking columns 25, 26, 27a, 27b and 27c, and 28. Each of the entries in columns 25 to 28 has three alternative states “-”, “1”, or “O”.

Column 25 (O-flag) indicates whether a validity check regarding a predecessor electronic coin data set in column 22a/b was successful. The “1” state indicates that a validity check revealed that the electronic coin data set of column 22a/b is valid and the “0” state indicates that a validity check revealed that the electronic coin data set of column 22a/b is invalid and the “-” state indicates that a validity check has not yet been completed. For multiple predecessor coin data sets, it is preferred to use a combined 0-flag (both valid) rather than two separate O-flags. The column 26 (C-flag) indicates whether a first check calculation for the masked electronic coin data sets was successful. The first check calculation checks in particular whether the command is amount-neutral, thus primarily that the sum of the monetary amounts involved is zero. The “1” state means that a calculation was successful and the “0” state indicates that the calculation was not successful and the “-” state indicates that a calculation has not yet been completed.

For example, the calculation to be performed in column 26 is:

(Z_{O1}+Z_{O2})−(Z_{S1}+Z_{S2})==0 (10)

Column 27a (R1-flag) indicates whether a first check of a range proof or of the range proof was successful. The same holds for the further columns 27b (R2-flag) and 27c (R3-flag). The “1” state means that a validity check showed that the range proofs or the range proof are or is retraceable and the “0” state indicates that a validity check resulted in that the range proofs or the range proof could not be retraced and the “-” state indicates that a validity check is not yet completed, was not successful. The first range proof of column 27a is always necessary for the coin data set(s) to be considered valid. A typical example of a necessary check is the check that the monetary amount is not negative (or none of the monetary amounts are negative). The second and third range proofs do not affect the validity of the coin data set. The range proof in column 27b is used to check whether the monetary amount of the masked coin data set (or each coin data set) is below a maximum amount. The maximum amount can be predetermined system-wide or for specific terminal types. For example, the range proof of column 27c is used to compare a sum of monetary amounts (sent or) received by the participating unit TE in a specified time period, such as 24 hours, against a sum limit value, or to check, for example, a transaction count per time unit for the participating unit TE, such as a maximum of 5 per minute or 100 per day. The limit values can be predefined by the payment system BZ system-wide or defined for certain types of participating units (thus participating unit-specific). For example, a coffee machine of type X can only dispense four portions of hot drinks per minute due to the appliance and accordingly only four coin transactions per minute are permitted.

Column 28 (S-flag) indicates whether a signature of the electronic coin data set matches the signature of column 24, wherein “1” state indicates that a validity check resulted in that the signature could be identified as that of the issuer and “0” state indicates that a validity check revealed that the signature could not be identified as that of the issuing entity and the “-” state indicates that a validity check is not yet completed.

A change in the status of one of the markings (also referred to as a “flag”) requires approval by the coin register 2 and must then be stored unchangeably in the data structure of FIG. 7. Processing is final in anonymous mode (or for an anonymous masked coin data set) when and only when the required flags 25 to 28 have been validated by the coin register 6, i.e. changed from “0” state to “1” state or “1” state after the corresponding check.

In the following, a data structure without completion markings 29 is assumed and the validity of anonymous coin data sets is considered first. In order to determine whether a masked electronic coin data set Z is valid, the coin register 2 searches for the last change that regards the masked electronic coin data set Z. It holds that the masked electronic coin data set Z is valid if the masked electronic coin data set Z is listed for its last processing in one of the successor columns 23a, 23b, when and only when that last processing has the corresponding final marking 25 to 28. It also holds that the masked electronic coin data set Z is valid, if the masked electronic coin data set Z is listed for its last processing in one of the predecessor columns 22a, 22b, when and only when this last processing has failed, thus at least one of the corresponding required states of the markings 25 to 28 is set to “0”.

When the masked electronic coin data set Z is not found in the coin register 2, it is invalid. It also holds that the anonymous masked electronic coin data set Z is not valid for all other cases. For example, when the last processing of the masked electronic coin data set Z is listed in one of the successor columns 23a, 23b but this last processing never became final or when the last processing of the masked electronic coin data set Z is in one of the predecessor columns 22a, 22b and this last processing is final.

The checks occurring by the coin register 2 and/or monitoring register 6 to determine whether a processing is final are represented by columns 25 to 28: The state in column 25 indicates whether the masked electronic coin data set(s) is/are valid according to predecessor columns 22a, 22b. The state in column 26 indicates whether the calculation of the masked electronic coin data set is correct according to equation (10). The state in column 27a indicates whether the range proofs for the masked electronic coin data set Z could be successfully checked. The state in column 28 indicates whether the signature in column 24 of the masked electronic coin data set Z is a valid signature of issuing entity 1.

The “0” status in a column 25 to 28 here indicates that the check was not successful. The “1” status in a column 25 to 28 here indicates that the check was successful. The “-” state in a column 25 to 28 indicates that no check occurred. The states can also have a different value, as long as a clear distinction can be made between success/failure of a test and it is evident whether a particular test was performed.

As an example, five different processings are defined, which are explained in detail here. Reference is made to the corresponding list entry in FIG. 7.

One processing is, for example, “generating” an electronic coin data set Cᵢ. Generating in the direct transaction layer 3 by the issuing entity 1 includes selecting a monetary amount vᵢ and creating an obfuscation amount rᵢ, as described earlier with equation (1). As shown in FIG. 7, no entries/markings are required in columns 22a, 22b, 23b and 25 to 27 during the “generating” processing. The masked electronic coin data set Zᵢ is registered in the successor column 23a. This registration preferably occurs before transmitting 105 to a participating unit TE, in particular or already at the time of generating by the issuing entity 1, and in both cases equation (3) must be performed for this purpose. The masked electronic coin data set Zᵢ is signed by the issuing entity 1 upon creating, this signature is entered into column 24 to ensure that the electronic coin data set Cᵢ has indeed been created by an issuing entity 1, although other methods may also be used for this purpose. If the signature of a received Cᵢ matches the signature in column 24, the marking in column 28 is set (from “0” to “1”). The markings according to columns 25 to 27 do not require a status change and can be ignored. The range proof is not needed because the coin register 2 can trust that the issuing entity 1 does not issue negative monetary amounts. In an alternative embodiment, however, it can be sent by the issuing entity 1 together in the creating command and checked by coin register 2.

For example, one processing is “deactivating”. Deactivating 111, thus destroying money, causes the masked electronic coin data set Zᵢ to become invalid after successful execution of the deactivating command by the issuing entity 1, see also FIG. 13. One can therefore no longer process the (masked) electronic coin data set to be deactivated in the coin register 2. To avoid confusion, the corresponding (non-masked) electronic coin data sets Cᵢ should also be deactivated in the direct transaction layer 3. When “deactivating” 111, the predecessor column 22a is written to with the electronic coin data set Zᵢ, but no successor column 23a, 23b is occupied. The masked electronic coin data set Zᵢ shall be checked during deactivating to ensure that the signature matches the signature according to column 24 to ensure that the electronic coin data set Cᵢ has indeed been created by an issuing entity 1, wherein again other means may be used for this check. If the signed Cᵢ sent along in the deactivating command can be confirmed as signed by the issuing entity 1, the marking 28 is set (from “0” to “1”). The markings according to columns 26 to 27 do not require a status change and can be ignored. The markings according to columns 25 and 28 are set after corresponding check.

A processing (modification) is, for example, “splitting”. Splitting 110, i.e. dividing an electronic coin data set Zᵢ into a number n, for example 2, of electronic coin data sets Zⱼ and Zₖ is first performed in the direct transaction layer 3, as still shown in FIGS. 8 and 12, whereby the monetary amounts vⱼ and of the obfuscation amount rⱼ are generated. vₖ and rₖ result from the equations (7) and (8). In the coin register 2, the markings 24 to 27 are set, the predecessor column 22a is written with electronic coin data set Zᵢ, the successor column 23a is written with Zⱼ and the successor column 23b is written with Zₖ. The status changes required according to columns 24 to 27 are made after the corresponding check by the coin register 2 and document the respective check result. The marking according to column 28 is ignored in particular in anonymous mode. A first range proof R1 according to column 27a must be provided, for example, to show that no monetary amount is negative. A second range proof R2 in column 27b is not necessary because the monetary sub-amounts of the successor are always smaller than the initial monetary amount of the predecessor. A sum range proof R3 in column 27c is also usually not necessary (no new monetary amounts). The column 24 is used for entering a signature which was generated by a participating unit TE splitting the coin data set.

For example, one processing is “merging”. Merging 109, thus the joining of two electronic coin data sets Zᵢ and Zⱼ into one electronic coin data set Zₘ, is first carried out in the direct transaction layer 3, as still shown in FIGS. 9 and 11, whereby the monetary amount vm and the obfuscation amount rm are calculated. In the coin register 2, the markings 25 to 28 are set, the predecessor column 22a is written with the electronic coin data set Zᵢ, the predecessor column 22b is written with Zⱼ, and the successor column 23b is written with Zₘ. The markings in columns 25 to 28 require status changes and the coin register 2 performs the corresponding checks. A first range proof R1 according to column 27a must be provided to show that no new money has been generated. A second range proof R2 in column 27b is useful because the new monetary amount of the successor could be greater than a maximum value. A sum range proof R3 in column 27c is also usually useful, as the terminal could be employing newly received predecessors. The marking according to column 28 can be ignored. The column 24 is used for entering a signature generated by a participating unit TE merging the coin data sets.

A further processing is, for example, “switching”. Switching 108 is necessary when an electronic coin data set has been transmitted to another participating unit TE and a repeated outputting by the transmitting participating unit TE is to be prevented. When switching, the electronic coin data set Cₖ obtained from the first participating unit TE1 is exchanged for a new electronic coin data set Cᵢ with the same monetary amount. The new electronic coin data set Cᵢ is generated by the second participating unit TE2. This switching is necessary to invalidate (make invalid) the electronic coin data set Cₖ obtained from the first participating unit TE2, thus preventing the same electronic coin data set Cₖ being output repeatedly. This is because, as long as the electronic coin data set Cₖ is not switched, and since the first participating unit TE1 has knowledge about the electronic coin data set Cₖ, the first participating unit TE1 can pass on this electronic coin data set Cₖ to a third participating unit TE. The switching occurs, for example, by adding a new obfuscation amount r_{add} to the obfuscation amount rₖ of the obtained electronic coin data set Cₖ, thereby obtaining an obfuscation amount rᵢ that is known only by the second participating unit TE2. This can also occur in the coin register 2. To prove that only a new obfuscation amount r_{add} has been added to the obfuscation amount rₖ of the masked received electronic coin data set Zₖ, but the monetary amount has remained the same, and thus equation (11):

vₖ−vₗ (11)

holds, then the second participating unit TE2 must be able to prove that Zᵢ−Zₖ can be represented as a scalar multiple of G, thus as r_{add}*G. This means that only one obfuscation amount r_{add} has been generated and the monetary amount of Zᵢ is equal to the monetary amount of Zₖ, thus Zᵢ=Zₖ+r_{add}*G. This occurs by generating a signature with the public key Zⱼ−Zₖ−r_{add}*G.

The “splitting” and “merging” modifications to an electronic coin data set can also be delegated from one participating unit TE1 to another participating unit TE, for example when a communication link to the coin register 2 is not available.

FIG. 8 shows an example embodiment of a payment system BZ according to the invention regarding the “splitting”, “merging” and “switching” of electronic coin data sets C. In FIG. 8, the first participating unit TE1 obtained the coin data set Cᵢ and now seeks to perform a payment transaction not with the whole monetary amount, but only with a sub-amount vₖ. For this purpose, the coin data set Cᵢ is split. First, the monetary amount is divided:

vᵢvⱼ+vₖ (12)

Each of the obtained values vⱼ, vₖ, here must be greater than 0, because negative monetary amounts are not permitted.

In a preferred embodiment, the monetary amount vᵢ is divided symmetrically into a number n of equally sized monetary sub-amounts vⱼ.

vⱼ=vᵢ/n (12a)

The number n is an integer greater than or equal to two. For example, a monetary amount of 10 units can be split into 2 sub-amounts of 5 units (n=2) or into 5 sub-amounts of 2 units each (n=5) or 10 sub-amounts of one unit each (n=10).

In addition, new obfuscation amounts are derived:

rᵢ=rⱼ+rₖ (13)

When split symmetrically, an individual unique obfuscation amount rⱼ is formed in the participating unit TE1 for each coin sub-amount, wherein the sum of the number n of obfuscation amounts rⱼ of the coin data sets is equal to the obfuscation amount rᵢ of the split coin data set:

rᵢ=Σₖ₌₁ⁿ=r_{j_k} (13a)

In particular, it holds that the last obfuscation sub-amount rⱼ_n is equal to the difference of the obfuscation amount rᵢ and the sum of the remaining obfuscation sub-amounts:

r_{j_n}=rᵢ−Σₖ₌₁ⁿ⁻¹r_{j_k} (13b)

In this way, the concealment amounts r_{j_1} to r_{j_n-1} can be chosen arbitrarily and the rule of equation (13a) is fulfilled by calculating the “last” individual concealment amount r_{j_n} accordingly.

For asymmetric splitting, masked coin data sets Zⱼ and Zₖ are obtained from the coin data sets and Cₖ according to equation (3) and registered in the coin register 2 and/or the monitoring register 6. For the splitting, the predecessor column 22a is written with coin data set Zᵢ, the successor column 23a is written with Zⱼ and the successor column 23b is written with Zₖ. Additional information for the range proof (zero-knowledge-proof) is to be generated. The markings in columns 25 to 27 require status change and the coin register 2 and/or the monitoring register 6 performs the corresponding checks. The marking according to column 28 and the status according to column 29 are ignored.

In the case of symmetrical splitting, a signature is calculated in the respective participating unit TE. For this purpose, the following signature key sig is used for the k-th coin sub data set C_{j_k}:

sig=rᵢ−n·r_{j_k} (13c)

Here, n is the number of symmetrically split coin data subsets. In case of symmetrically splitting, the signature of the k-th coin data subset k can be checked according to (13c) with the following verification key Sig:

Sig=Zᵢ−n·Z_{j_k} (13d)

Here, Z_{j_k} is the masked k-th coin data subset and n is the number of symmetrically split coin data subsets. This simplification results from the connection with equation (3):

Zᵢ−n·Z_{j_k}=(vᵢ−n·v_{j_k})·H+(rᵢ−n·r_{j_k})·G (13e)

wherein by the symmetry properties of the split holds:

(vᵢ−n·v_{j_k})·H=0 (13f)

so that equation 13e is simplified to:

Zᵢ−n·Z_{j_k}=(rᵢ−n·r_{j_k})·G (13g)

The simplification due to equation 13f allows to completely dispense with zero-knowledge-proofs, whereby the application of a symmetrical distribution saves enormous computing power and data volume.

Then a coin data subset, here Cₖ, is transmitted from the first participating unit TE1 to the second participating unit TE2. To prevent double spending, a switching operation is useful to exchange the electronic coin data set Cₖ obtained from the first participating unit TE1 for a new electronic coin data set Cᵢ with the same monetary amount. The new electronic coin data set Cᵢ is generated by the second participating unit TE2. In this process, the monetary amount of the coin data set Cᵢ is adopted and not changed, see equation (11).

Then, according to equation (14), a new obfuscation amount r_{add} is added to the obfuscation amount rₖ of the obtained electronic coin data set Cₖ,

rₗ=rₖ+r_{add} (14)

obtaining an obfuscation amount n that is known only by the second participating unit TE2. To prove that only a new obfuscation amount r_{add} has been added to the obfuscation amount rₖ of the obtained electronic coin data set Zₖ, but that the monetary amount has remained the same (vₖ=vₗ), the second participating unit TE2 must be able to prove that Zₗ−Zₖ can be represented as a multiple of G. This is done by public signature r_{add} according to equation (15):

R_{add}=r_{add}·G=Zₗ−Zₖ=(vₗ−vₖ)*H+(rₖ+r_{add}−rₖ)*G (15)

wherein G is the generator point of the ECC. Then the coin data set Cᵢ to be switched is masked by means of equation (3) to obtain the masked coin data set Zₗ. In the coin register 2 and/or the monitoring register 6, the private signature r_{add} can then be used to sign, for example, the masked coin data set to be switched Zₗ, which is considered as proof that the second participating unit TE2 has only added an obfuscation amount r_{add} to the masked coin data set and no additional monetary amount, i.e. vₗ=vₖ.

The proof is as follows:

Zₖ=vₖ·H+rₖ·G Zₗ=vᵢ·H+rₗ·G=vₖ·H+(rₖ+r_{add})·G Zₗ−Zₖ=(rₖ+r_{add}−rₖ)·G r_{add}·G (16)

FIG. 9 shows an example embodiment of a payment system according to the invention for merging (also called combining) electronic coin data sets. The two coin data sets Cᵢ and Cⱼ are obtained in the second participating unit TE2. Following the splitting according to FIG. 8, a new coin data set Zₘ is obtained by adding both the monetary amounts and the obfuscation amount of the two coin data sets Cᵢ and Cⱼ. Then the obtained coin data set Cₘ to be merged is masked and the masked coin data set Zₘ is registered in the coin register 2. Then, upon “merging”, the signature of the second participating unit TE2, as it has obtained the coin data sets Cᵢ and Cⱼ, is entered.

Upon combining by the payment system BZ, the highest of the two individual check values of the respective electronic coin data subsets Cᵢ and Cⱼ is determined. This highest check value is adopted as the check value Cᵢ and of the combined electronic coin data set.

Alternatively, when combining (=merging) by a payment system BZ, a new check value is determined from the sum of all check values of the electronic coin data subsets Cᵢ and divided by the product of the number (here two) of coin data subsets Cᵢ and with a constant correction value. The correction value is constant throughout the payment system. The correction value is greater than or equal to 1. Preferably, the correction value is dependent on a maximum deviation of the individual check values of the electronic coin data subsets Cᵢ and Cⱼ or on a maximum check value of one of the electronic coin data subsets Cᵢ and Cⱼ. Further preferably, the correction value is smaller than or equal to 2. This new check value is adopted as the check value of the combined electronic coin data set Cₘ.

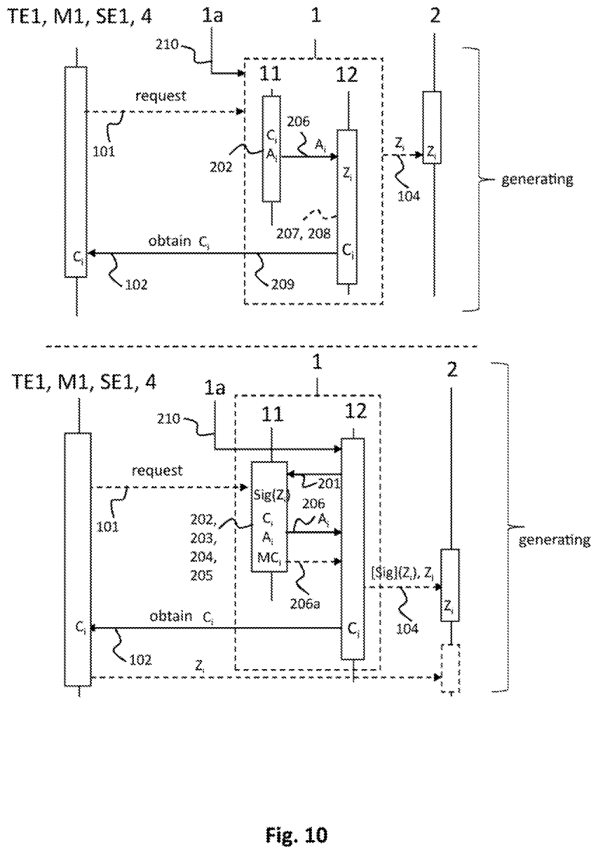

FIGS. 10 to 14 each show an example embodiment of a method flow diagram of a method 100. FIGS. 10 to 14 are explained in combination below. In the optional steps 101 and 102, a coin data set C is requested and provided by the issuing entity 1 to the first participating unit TE1 after creating the electronic coin data set in step 102.

In a first embodiment of FIG. 10 (above the dashed dividing line), a request 210 of a central bank 1a in the issuing entity 1 is used to generate an eMDS C. This is done according to the steps in the method flow diagram of method 200 according to FIG. 6. In step 202, the eMDS C is generated and provided as a printout A to the coin output unit 12 in the air gap process 206. The unit 12 obtains the eMDS C and the signature of the issuer (as an issuance security value) and optionally creates the RDS in step 207. Finally, the RDS is registered with the coin register 2 in step 104, if the signature is valid. By request 101, the eMDS C is provided to the TE1 at step 209 (102).

In a second embodiment of FIG. 10 (below the dashed dividing line), the request 210 of a central bank 1a in the issuing entity 1 is used to generate an eMDS C. For this purpose, the request is directed to the unit 11 in step 201, preferably as an air gap process. This is done according to the steps in the method flow diagram of method 200 according to FIG. 6. In steps 202, 203, 204, the eMDS C, the RDS and the signed RDS are generated and provided as a printout A to the coin output unit 12 in the air gap process 206. The unit 12 obtains the eMDS C, the RDS, and the signed RDS. In addition, metadata MC is generated in step 205 and provided to unit 12 in step 206a.

Finally, the RDS and the signed RDS are registered at the coin register 2 at step 104. By the request 101, the eMDS C is provided to the TE1 at step 209 (102). Alternatively, only the signed RDS is provided by the unit 12 to the coin register 2 and the RDS is generated in the TE1 and then sent to the coin register 2 (depicted dashed).

According to FIG. 11, a signed masked electronic coin data set is sent to the coin register 2 in step 103. In step 103, a masking of the obtained electronic coin data set Cᵢ according to equation (3) and a signing in step 103p according to equation (3a) occurs. Then, in step 104, the masked electronic coin data set Zᵢ is registered in the coin register 2. Optionally, the participating unit TE1 can switch the obtained electronic coin data set, and in that case, a signature Si would be entered into the coin register 2. In step 105, the transmitting of the coin data set Cᵢ in the direct transaction layer 3 to the second participating unit TE2 occurs. In the optional steps 106 and 107, a validity check with prior masking occurs, in which the coin register 2 confirms the validity of the coin data set Zᵢ or Cᵢ in a good case.

In optional step 108, the switching of an obtained coin data set Cₖ (of course, the obtained coin data set Cᵢ could also be switched) to a new coin data set Cᵢ occurs, which invalidates the coin data set Cₖ and prevents double spending. For this purpose, the monetary amount vₖ of the transmitted coin data set Cₖ is used as the “new” monetary amount vᵢ. In addition, as already explained with equations (14) to (17), the obfuscation amount rᵢ is created. The additional obfuscation amount r_{add} is used to prove that no new money (in the form of a higher monetary amount) has been generated by the second participant unit TE2. Then the masked coin data set is signed and the signed masked coin data set Zᵢ to be switched is sent to the coin register 2 and the switching from Cₖ to Cᵢ is ordered. In addition, a signature Sk is created by the first participating unit TE1 or the second participating unit TE2 and stored in the coin register 2. Additionally or alternatively, a signature Si could be created and stored in the coin register 2 when sending participating units TE were registered instead of receiving participating units TE.

In step 108′, the corresponding check occurs in coin register 2. In this process, Zₖ is entered in column 22a according to the table in FIG. 7 and the coin data set Zᵢ to be rewritten is entered in column 23b. A check is then made in coin register 2 as to whether Zₖ is (still) valid, thus whether the last processing of Zₖ is entered in one of the columns 23a/b (as proof that Zₖ has not been further split or deactivated or merged) and whether a check for the last processing has failed. In addition, Zᵢ is entered into column 23b and the markings in columns 25, 26, 27 are initially set to “0”. Now a check occurs whether Zᵢ is valid, wherein the check according to equations (16) and (17) can be used. In a good case, the marking in column 25 is set to “1”, otherwise to “0”. Now a check occurs, the calculation according to equation (10) results in that Zₖ and Zᵢ are valid and accordingly the marking in column 26 is set. Furthermore, it is checked whether the ranges are conclusive, then the marking is set in column 27. Then the signature Si is verified with the corresponding public verification key present in the coin register 2 and logged accordingly. If all checks have been successful and this has been recorded unchangeable accordingly in the coin register 2, the coin data set is considered to have been switched. I.e., the coin data set Cₖ is no longer valid and from now on the coin data set Cᵢ is valid. Double-spending is no longer possible when a third participating unit TE inquires about the validity of the (double-output) coin data set at the coin register 2 and/or the monitoring register 6. When checking the signature, it can be checked in pseudonymous mode whether the second participating unit TE2 has exceeded a monetary amount limit value. The check is performed with respect to a time unit, for example a daily limit value could be monitored with it. If the limit value is exceeded, the coin register 2 first refuses the switching of the coin data set Cᵢ and requests the second participating unit TE2 to deanonymise. Due to the system, de-anonymised switching may possibly be permitted.

In optional step 109, two coin data sets Cₖ and Cᵢ are merged into a new coin data set Cₘ, which invalidates the coin data sets Cₖ, Cᵢ and prevents double spending. For this purpose, the monetary amount vm is formed from the two monetary amounts vₖ and vᵢ. For this purpose, the obfuscation amount rm is formed from the two obfuscation amounts rₖ and rᵢ. In addition, the masked coin data set Zₘ to be merged is obtained by means of equation (3) and this is sent (together with other information) to the coin register 2 and the merging is requested as processing. In addition, a signature Sₖ and a signature Sᵢ are generated and communicated to the monitoring register 6 and/or the coin register 2.

In step 109′, the corresponding check occurs in the coin register 2. Zₘ is entered into column 23b according to the table in FIG. 7, which also corresponds to a rewriting. A check then occurs in the coin register 2 as to whether Zₖ and Zᵢ are (still) valid, thus whether the last processing of Zₖ or Zᵢ is entered in one of the columns 23a/b (as proof that Zₖ and Zᵢ have not been further split or deactivated or merged) and whether a check for the last processing has failed. In addition, the markings in columns 25, 26, 27 are initially set to “0”. Now a check occurs whether Zₘ is valid, wherein the check according to equations (16) and (17) can be used. In a good case, the marking in column 25 is set to “1”, otherwise to “0”. Now a check occurs, the calculation according to equation (10) results in that Zᵢ plus Zₖ equals Zₘ and accordingly the marking in column 26 is set. Furthermore, it is checked whether the ranges are conclusive, then the marking is set in column 27. Upon checking the signature, it can be checked whether the second participating unit TE2 has exceeded a limit value for monetary amounts. The check occurs with regard to a time unit, for example a daily limit value could be monitored with it.

In optional step 110, an asymmetric splitting of a coin data set Cᵢ into two coin data sets Cₖ and Cⱼ occurs, whereby the coin data set Cᵢ is invalidated and the two asymmetrically split coin data sets Cₖ and Cⱼ are to be validated. Upon asymmetric splitting, the monetary amount vᵢ is split into monetary sub-values vₖ and vₗ of different sizes. For this purpose, the obfuscation amount rᵢ is split into the two obfuscation amounts rₖ and rₗ. In addition, by means of equation (3), the masked coin data subsets Zₖ and Zⱼ are obtained and sent to the coin register 2 with further information, for example, the range proofs (zero-knowledge-proofs), and the splitting is requested as processing. In addition, a signature Si is created and sent to the coin register 2.

In step 110′, the corresponding check occurs in the coin register 2 and/or the monitoring register 6. In this process, Zⱼ and Zₖ are entered into columns 23a/b according to the table in FIG. 7. A check then occurs in the coin register 2 as to whether Zᵢ is (still) valid, thus whether the last processing of Zᵢ is entered in one of the columns 23a/b (as proof that Zᵢ has not been further split or deactivated or merged) and whether a check for the last processing has failed. In addition, the markings in columns 25, 26, 27 are initially set to “0”. Now a check occurs whether Zⱼ and Zₖ are valid, wherein the check according to equations (16) and (17) can be used. In the good case, the marking in column 25 is set to “1”. Now a check occurs, the calculation according to equation (10) results in that Zᵢ is equal to Zₖ plus Zⱼ and accordingly the marking in column 26 is set. Furthermore, it is checked whether the ranges are conclusive, then the marking is set in column 27. Upon checking the signature, it can be checked whether the second participating unit TE2 has exceeded a limit value for monetary amounts. The check occurs regarding a time unit, for example a daily limit value could be monitored with it.

FIG. 13 shows an exemplary deactivating according to the invention. In this case, a deactivating request 111 is sent from the TE1 to the coin output unit 12. The coin output unit 12 creates a deletion request 212 and sends it to the coin register 2 to delete the RDS to the eMDS C to be deactivated. The monetary amount of the eMDS C is credited to an account of the participant.

Within the scope of the invention, all elements described and/or drawn and/or claimed may be combined with one another in any desired manner.

1.-33. (canceled)

34. An issuing entity for issuing electronic coin data sets in a payment system, with:
a coin generating unit configured for generating an electronic coin data set; and
a coin output unit configured for obtaining the electronic coin data set generated by the coin generating unit and for outputting the electronic coin data set to a participating unit or a bank entity of the payment system in electronic form,
wherein the issuing entity is configured such that the transmitting of the electronic coin data set between the coin generating unit and the coin output unit occurs via an air gap process.

35. The issuing entity according to claim 34, wherein the air gap process between the coin generating unit and the coin output unit is configured to physically separate the coin generating unit from the coin output unit.

36. The issuing entity according to claim 34, wherein the air gap process comprises a physical transmitting of the electronic coin data set between the coin generating unit and the coin output unit, in particular by means of a portable data carrier, and/or a transmitting by means of a secured transport container.

37. The issuing entity according to claim 34, wherein the transmitting occurs by means of a portable electronic data storage.

38. The issuing entity according to claim 34, wherein for transmitting by air gap process:
the coin generating unit is further configured for generating a printout representing the electronic coin data set; and
the coin output unit is further configured for obtaining the electronic coin data set generated by the coin generating unit by reading the printout.

39. The issuing entity according to claim 38, wherein the printout has at least one of the following elements:
an alphanumeric character string;
an opto-electronically readable code, in particular a two-dimensional code;
a laser engraving.

40. The issuing entity according to claim 38, wherein the printout occurs on paper substrate or plastic substrate in banknote format.

41. The issuing entity according to claim 38, wherein the printout occurs on paper in DIN A4 format.

42. The issuing entity according to claim 38, wherein multiple coin data sets are arranged on a printout.

43. The issuing entity according to claim 34, wherein the coin output unit has a banknote processing machine.

44. The issuing entity according to claim 34, wherein the coin output unit has a reader for opto-electronically reading the printout.

45. The issuing entity according to claim 34, wherein the coin output unit has a reader for opto-electronically reading a generation request.

46. The issuing entity according to claim 38, wherein the coin output unit has:
a checking device for checking the printout, and/or
a printout destruction unit for destroying printouts.

47. The issuing entity according to claim 34, wherein the coin generating unit is further configured for generating a signature for the electronic coin data set by signing the electronic coin data set with a private cryptographic key part of the issuing entity, wherein the generated electronic coin data set comprises the signature.

48. The issuing entity according to claim 34, wherein the coin generating unit is further configured for generating issuer security data, and the coin output unit also obtains the generated issuer security data from the coin generating unit via the air gap process.

49. The issuing entity according to claim 34, wherein the coin generating unit is configured for generating a register data set which is intended for storage in a coin register of the payment system, and
wherein p the coin output unit also obtains the generated register data set from the coin generating unit via the air gap process.

50. The issuing entity according to claim 49, wherein the coin output unit is configured for registering the electronic coin data set in the coin register by outputting the register data set and the issuer security data to the coin register,
wherein either the register data set comprises the issuer security data for storing in the coin register or the issuer security data is outputted in addition to the register data set to be stored.

51. The issuing entity according to claim 48, wherein the register data set has one or more of the following data elements:
a masked electronic coin data set, in particular generated by applying a homomorphic one-way function to the electronic coin data set;
a signature as issuer security data, in particular as signature of the electronic coin data set, the register data set, and/or a masked electronic coin data set;
a range proof of the electronic coin data set;
a check value regarding the electronic coin data set; and/or
a monetary amount of the electronic coin data set.

52. The issuing entity according to claim 48, wherein
the coin generating unit is configured for signing the register data set, in particular of at least one masked electronic coin data set, with a private cryptographic key part of the issuing entity; and/or
the coin output entity both authenticates itself to a coin register and outputs the issuer security data to the coin register, in particular as a signature of the register data set and/or of a masked electronic coin data set.

53. The issuing entity according to claim 34, wherein each electronic coin data set has at least a monetary amount as a data element and an obfuscation amount as a data element, wherein the obfuscation amount is secret for a coin register; and
further has a check value as a data element which has a value of zero upon generating the electronic coin data set.
